(19) United States
(12) Patent Application Publication
(10) Pub. No.: US 2017/0168610 A1
(43) Pub. Date: Jun. 15, 2017

(54) APPARATUS AND METHOD FOR PROVIDING INFORMATION IN ELECTRONIC DEVICE

(71) Applicant: SAMSUNG ELECTRONICS CO., LTD., Suwon-si (KR)

(72) Inventors: Insik MYUNG, Incheon (KR); Taeho WANG, Seoul (KR); Jungwon LEE, Seoul (KR); Hye Won LEE, Seoul (KR)

(21) Appl. No.: 15/374,199

(22) Filed: Dec. 9, 2016

(30) Foreign Application Priority Data
Dec. 11, 2015 (KR) 10-2015-0177316

(51) Int. Cl. G06F 3/044; G06F 3/0482; G06F 3/0488; G06F 3/0486

(52) U.S. Cl. CPC G06F 3/044; G06F 3/0486; G06F 3/0482; G06F 3/0488

(57) ABSTRACT

Various example embodiments of the present disclosure relates to an electronic device for displaying and transceiving information and an operation method thereof. According to various example embodiments of the present disclosure, a method for providing information in an electronic device includes the operations of sensing a current context of the electronic device, displaying first information corresponding to the sensed current context in a first region of a screen, displaying second information in a second region of the screen, and controlling the first information based on an operation that the second information indicates when an input is sensed.

### CROSS-REFERENCE TO RELATED APPLICATION

This application is based on and claims priority under 35 U.S.C. §119 to Korean Application Serial No. 10-2015-0177316, which was filed in the Korean Intellectual Property Office on Dec. 11, 2015 the content of which is incorporated by reference herein in its entirety.

### BACKGROUND

1. Field of the Disclosure

The present disclosure relates generally to an electronic device for displaying and transceiving information and an operation method thereof.

2. Description of Related Art

Recently, with the growth of digital technologies, various types of electronic devices are being widely used such as wearable devices, mobile communication terminals, smart phones, tablet Personal Computers (PCs), Personal Digital Assistants (PDAs), electronic organizers, notebook computers, cameras, etc. Users can use the various types of electronic devices to transceive information. For example, the electronic devices can provide a calling function such as a voice call, a video call, etc., a message transceiving function such as a Short Message Service (SMS)/Multimedia Message Service (MMS), an electronic mail (e-mail), etc., an electronic organizer function, a broadcast play function, a video play function, a music play function, an Internet function, a messenger function, a game function, or a Social Networking Service (SNS) function, etc. When a user transceives the information by using the electronic device, there is a need for a method for transceiving information even by simple handling only for convenience sake.

### SUMMARY

Various example embodiments of the present disclosure provide an electronic device and method for displaying information.

Also, various example embodiments of the present disclosure provide an electronic device and method for sharing information.

Also, various example embodiments of the present disclosure provide an apparatus and method capable of displaying and sharing user's current state information and a user's intention.

According to various example embodiments of the present disclosure, a method for providing information in an electronic device is provided. The method includes the operations of sensing a current context of the electronic device, displaying first information corresponding to the sensed current context in a first region of a screen, displaying second information in a second region of the screen, and, as an input is sensed, controlling the first information based on an operation that the second information indicates.

An electronic device according to various example embodiments of the present disclosure includes a display configured to display a first region and a second region, an input unit comprising input circuitry, and a processor operatively coupled with the display and the input unit. The processor is configured to sense a current context of the electronic device, and to control the display to display first information corresponding to the sensed current context in the first region, and to control the display to display second information in the second region and, as an input received from the input circuitry of the input unit is sensed, to control the first information based on an operation that the 2nd information indicates.

### BRIEF DESCRIPTION OF THE DRAWINGS

The above and other aspects, features and attendant advantages of the present disclosure will become more readily apparent and understood from the following detailed description, taken in conjunction with the accompanying drawings, in which like reference numerals refer to like elements, and wherein:

FIG. 1 is a block diagram illustrating an example electronic device for information provision according to various example embodiments of the present disclosure;

FIGS. 2A and 2B are diagrams illustrating an example basic screen configuration of an electronic device for information provision according to various example embodiments of the present disclosure;

FIG. 3 is a flowchart illustrating an example operation of providing information in an electronic device according to various example embodiments of the present disclosure;

FIG. 4 is a diagram illustrating an example of a screen for providing information in an electronic device according to various example embodiments of the present disclosure;

FIG. 5 is a flowchart illustrating an example operation of sharing information in an electronic device according to various example embodiments of the present disclosure;

FIGS. 6A, 6B and 6C are diagrams illustrating an example of sharing information in an electronic device according to various example embodiments of the present disclosure;

FIGS. 7A, 7B, 7C, 7D and 7E are diagrams illustrating an example of a screen displayed in an electronic device in accordance with an operation of sharing information illustrated in FIG. 5.

FIGS. 8A, 8B, 8C, 8D, 8E, 8F, 8G and 8H are diagrams illustrating an example of user contextual information displayed in an electronic device according to various example embodiments of the present disclosure;

FIGS. 9A, 9B, 9C, 9D, 9E, 9F and 9G are diagrams illustrating an example of user intention information displayed in an electronic device according to various example embodiments of the present disclosure;

FIGS. 10A, 10B and 10C are diagrams illustrating an example of a screen for providing location information among contextual information according to various example embodiments of the present disclosure;

FIGS. 11A, 11B, 11C, 12A, 12B and 12C are diagrams illustrating examples of a screen for, when an electronic device is located in a specific place, providing information about the specific place among contextual information according to various example embodiments of the present disclosure;

FIGS. 13A, 13B, 13C, 14A, 14B, 14C and 14D are diagrams illustrating examples of a screen for providing information according to a traffic means among contextual information according to various example embodiments of the present disclosure;

FIGS. 15A, 15B, 15C and 15D are diagrams illustrating an example of a screen for providing user preference information among contextual information according to various example embodiments of the present disclosure;

FIGS. 16A, 16B and 16C are diagrams illustrating an example of a screen for providing user intention information according to various example embodiments of the present disclosure;

FIGS. 17A and 17B are diagrams illustrating an example of a screen for forwarding a repeated pattern message according to various example embodiments of the present disclosure;

FIGS. 18A, 18B and 18C are diagrams illustrating an example of a screen for forwarding user proposal information according to various example embodiments of the present disclosure;

FIGS. 19A, 19B, 19C, 20A, 20B and 20C are diagrams illustrating examples of a screen for providing emotion information according to user's context according to various example embodiments of the present disclosure;

FIG. 21 is a flowchart illustrating an example operation of providing information according to location information and pose information in an electronic device according to various example embodiments of the present disclosure;

FIGS. 22A, 22B, 22C and 22D are diagrams illustrating an example of a screen for providing information according to location information and pose information in an electronic device according to various example embodiments of the present disclosure;

FIGS. 23A, 23B and 23C are diagrams illustrating an example of a screen for providing pose information sensed by location information in an electronic device according to various example embodiments of the present disclosure;

FIGS. 24A, 24B and 24C are diagrams illustrating an example of a screen for providing user's behavior information sensed by location information in an electronic device according to various example embodiments of the present disclosure;

FIG. 25 is a flowchart illustrating an example operation of providing information when receiving a call signal in an electronic device according to various example embodiments of the present disclosure;

FIGS. 26A, 26B, 26C, 26D and 26E are diagrams illustrating an example of a screen displayed in an electronic device in order to provide information when receiving a call signal in FIG. 25.

FIGS. 27A, 27B, 27C, 28A, 28B, 28C, 28D, 28E and 28F are diagrams illustrating examples of a screen for providing information when receiving a call signal in an electronic device according to various example embodiments of the present disclosure;

FIGS. 29A, 29B and 29C are diagrams illustrating an example of a screen for providing information quickly in an electronic device according to various example embodiments of the present disclosure;

FIG. 30 is a flowchart illustrating an example operation of providing information when sensing an external electronic device in an electronic device according to various example embodiments of the present disclosure;

FIGS. 31A, 31B, 31C, 32A, 32B, 32C and 32D are diagrams illustrating examples of a screen displayed in an electronic device in order to provide information when the electronic device senses an external electronic device in FIG. 30.

FIG. 33 is a flowchart illustrating an example operation of providing service information providable in accordance with a current state in an electronic device according to various example embodiments of the present disclosure;

FIGS. 34A and 34B are diagrams illustrating an example of a screen displayed in an electronic device in order to provide service information providable in accordance with a current state in the electronic device according to various example embodiments of the present disclosure;

FIGS. 35A, 35B and 35C are diagrams illustrating an example of a screen displayed in an electronic device in order to provide service information providable in accordance with a moving means in the electronic device according to various example embodiments of the present disclosure;

FIGS. 36A, 36B and 36C are diagrams illustrating an example of a screen displayed in an electronic device in order to provide service information providable in accordance with context in the electronic device according to various example embodiments of the present disclosure;

FIG. 37 is a flowchart illustrating an example operation for sharing contextual information with an external electronic device in an electronic device according to various example embodiments of the present disclosure; and

FIGS. 38A, 38B, 38C, 38D and 38E are diagrams illustrating an example of a screen displayed in an electronic device when the electronic device shares contextual information with an external electronic device in FIG. 37.

### DETAILED DESCRIPTION

Hereinafter, various example embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

The terms used herein are merely for the purpose of describing particular embodiments and are not intended to limit the scope of other embodiments. A singular expression may include a plural expression unless they are definitely different in a context. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device, or the like, but is not limited thereto.

Hereinafter, in various embodiments of the present disclosure, hardware approaches will be described as an example. However, various embodiments of the present disclosure include a technology that uses both hardware and software and thus, the various embodiments of the present disclosure may not exclude software approaches.

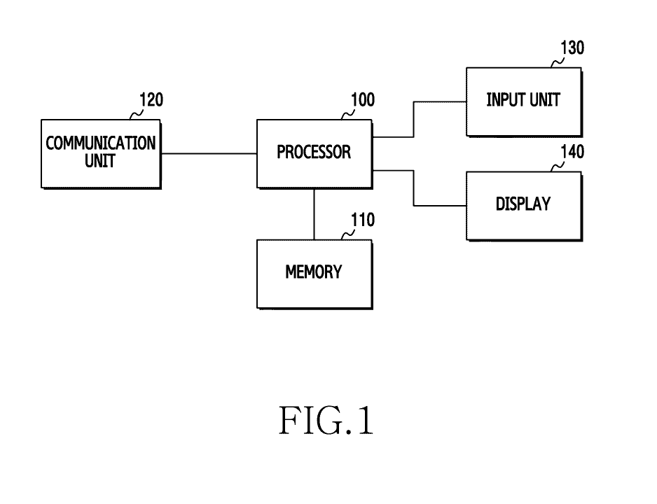

FIG. 1 is a block diagram illustrating an example configuration of an electronic device for information provision in various example embodiments of the present disclosure.

Referring to FIG. 1, the processor 100 can include various processing circuitry, including, for example, and without limitation, one or more of a dedicated processor, a Central Processing Unit (CPU), an Application Processor (AP), or a Communication Processor (CP), or the like. The processor 100 can, for example, execute operation or data processing concerned with control, image processing and/or communication of at least one another constituent element of the electronic device.

The memory 110 can include a volatile and/or non-volatile memory. The memory 110 can store a command or data related to at least one another constituent element of the electronic device. According to one example embodiment, the memory 110 can store a software and/or program. The program can, for example, include a kernel, a middleware, an Application Programming Interface (API), an application program (or “application”), etc. At least some of the kernel, the middleware, or the API can be called an Operating System (OS).

The communication unit 120 may include various communication circuitry and can, for example, set communication between the electronic device and an external device (i.e., an external electronic device or a server). For example, the communication unit 120 can be coupled to a network and communicate with the external device, through a wireless communication (for example, Long Term Evolution (LTE), Wireless Fidelity (WiFi), Bluetooth, Near Field Communication (NFC), etc.) or a wired communication (for example, a Universal Serial Bus (USB) cable).

The input unit 130 may include various input circuitry and can, for example, play a role of an interface capable of forwarding a command or data input from a user or another external device, to the other constituent element(s) of the electronic device. The input unit 130 according to an example embodiment of the present disclosure may include, for example, and without limitation, a touch panel.

The display 140 can, for example, include a Liquid Crystal Display (LCD), a Light Emitting Diode (LED) display, an Organic Light Emitting Diode (OLED) display, or a MicroElectroMechanical Systems (MEMS) display, or an electronic paper display, or the like, but is not limited thereto. The display 140 can, for example, display various contents (e.g., a text, an image, a video, an icon, a symbol, etc.) to a user.

The input unit 130 and the display 140 according to various example embodiments of the present disclosure can inlcude a one-piece touch screen. The touch screen can, for example, receive a touch, gesture, proximity, or hovering input that uses an electronic pen or a part of a user's body.

In the present disclosure, the term context can be a term referring, for example, to a current state of an electronic device or a user of the electronic device. Accordingly to this, the term contextual information can include information about a location, time, a service, a device, and/or a behavior.

In the present disclosure, the term 1st region can be a term referring, for example, to the whole screen of the electronic device. Also, the 1st region can mean the remnant region excluding a 2nd region among the whole region. The 1st region can include a plurality of regions as well.

In the present disclosure, the term 2nd region can be a term referring, for example, to a specific portion among the whole screen of the electronic device. The 2nd region may refer, for example, to a region displayed on the 1st region. Also, the 2nd region may refer, for example, to a portion overlaid on the 1st region. Accordingly, the 2nd region can include a plurality of regions as well.

An electronic device according to an example embodiment of the present disclosure can be a device worn on the human body, or be a device for displaying designated user's information although not directly worn on the human body. The context of the electronic device described later can include the context of the user of the electronic device.

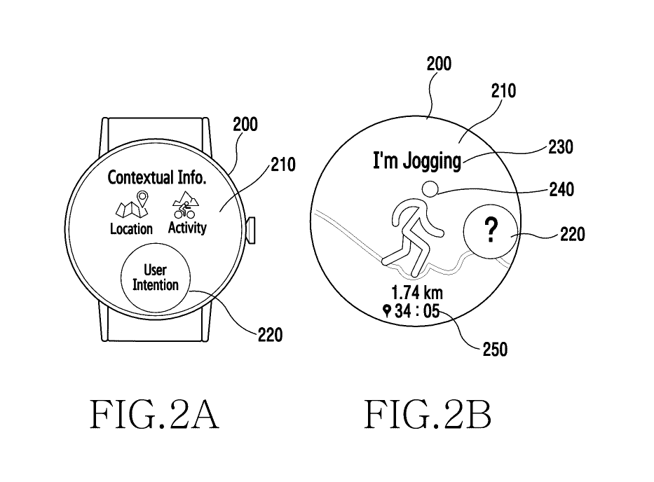

FIGS. 2A and 2B are diagrams illustrating an example basic screen configuration of an electronic device for information provision according to various example embodiments of the present disclosure.

Referring to FIG. 2A, the electronic device 200 can display a screen for providing information through the display 140, and the screen for providing the information can include a 1st region 210 and a 2nd region 220. Contextual information can be included in the 1st region 210 of the screen displayed to provide the information. The contextual information can include information about whether the electronic device 200 or a user of the electronic device 200 is now in which context. For example, the contextual information included in the 1st region can include location information and/or activity information. User intention information can be included in the 2nd region 220 of the screen displayed to provide the information. The user intention information can include information about an intention of the user of the electronic device 200. For example, the user intention information included in the 2nd region can include sharing information, execution information and/or coupling information. The sharing information can include information for fast communication of the user of the electronic device 200 with another user. For example, the sharing information can include information for sharing context and/or information for sharing an emotion. The execution information can include information for intuitive handling of the electronic device 200 by the user of the electronic device 200. For example, the execution information can include information for turning on/off an external electronic device and/or information for adjusting the device. The coupling information can include information that the user of the electronic device 200 needs for service coupling. For example, the coupling information can include information for calling a service, information for searching the service, etc.

FIG. 2B illustrates an example in which contextual information and intention information are displayed on a screen of the electronic device 200 according to one example embodiment of the present disclosure. Referring to FIG. 2B, environment information of the electronic device 200 or the user of the electronic device 200 can be displayed in the 1st region 210 of the electronic device 200 through a text and an image. In one example embodiment, in FIG. 2B, if the electronic device 200 senses a movement of the electronic device 200 or the user of the electronic device 200 and determines that the user of the electronic device 200 is now jogging, the electronic device 200 can display the text “I′m jogging” in a portion 230 of the 1st region 210 of the screen. In another example embodiment, the electronic device 200 can sense a movement of the user, and display an image that human is running, in a portion 240 of the 1st region 210 of the screen as well. The electronic device 200 can display additional information about displayed contextual information. According to one example embodiment, the electronic device 200 can display additional information highlighting contextual information such as a distance, time, a location, etc., as illustrated in a portion 250. The additional information can include information such as a waiting time, a progress, additional information, a detailed location, a price, etc.

In FIG. 2B, the electronic device 200 can display user's intention information according to a current state in the 2nd region 220 of the electronic device 200. For example of FIG. 2B, the electronic device 200 can display an image representing an intention of calling for help in the 2nd region 220. According to one example embodiment, besides the intention illustrated in the drawing, an image capable of displaying a user's intention by a symbolized four-corner element can be displayed in the 2nd region 220 of the electronic device 200. According to another example embodiment, the 2nd region 220 of the electronic device 200 can include information about check-in of a device or service coupled. According to a further example embodiment, the 2nd region 220 of the electronic device 200 can display a list of service functions selectable in user's current context. According to a yet another example embodiment, the 2nd region 220 of the electronic device 200 can display an event (i.e., a call, a message and/or a notification) taking place outside. Various example embodiments of the intention information capable of being displayed in the 2nd region 220 can include information about obstruction prohibition, question/proposal, preference indication, device control, emotion expression, service search/call, and/or service specialization functions.

According to various example embodiments of the present disclosure, 25 the electronic device 200 can combine contextual information displayed in the 1st region and intention information displayed in the 2nd region, and transmit to the external.

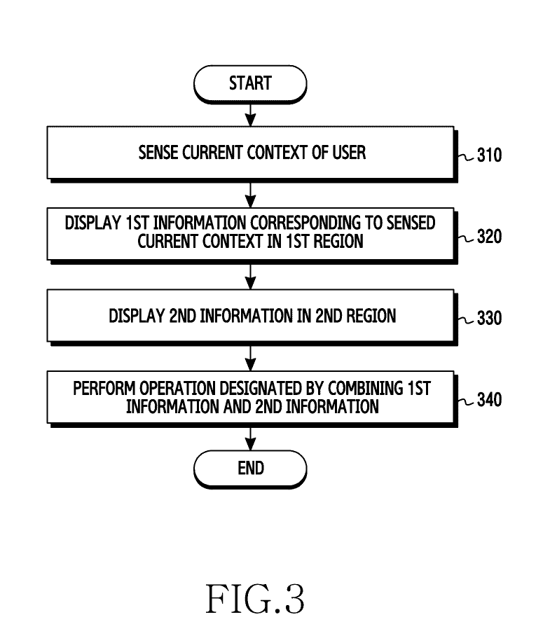

FIG. 3 is a flowchart illustrating an example operation of providing information in an electronic device according to various example embodiments of the present disclosure.

Referring to FIG. 3, in step 310, the electronic device 200 can sense information about current context. Below, the information about the current context may be referred to as contextual information. The contextual information can include information about whether the electronic device 200 or the user of the electronic device 200 is now in which context. According to an example embodiment of the present disclosure, context about the electronic device 200 and context about the user of the electronic device 200 can be the same as each other. The contextual information can include information about a current physical location of the electronic device 200, a movement of the user, a service coupled in a current location and/or a device coupled with the electronic device 200.

After sensing the current contextual information, the electronic device 200 can display the sensed current contextual information on a screen of the electronic device 200. The electronic device 200 can distinguish the screen into the 1st region 210 and the 2nd region 220 and display information in each region 210 or 220. In an example embodiment of the present disclosure, a description is made dividing into both the 1st region 210 and the 2nd region 220 but, in accordance with an example embodiment, the electronic device 200 can include only one region as well as both the 1st and 2nd regions, or can include three or more regions as well.

In operation 320, the electronic device 200 can display the sensed current contextual information as 1st information in the 1st region 210 of the screen. In case where the electronic device 200 displays the contextual information as the 1st information in the 1st region 210, the electronic device 200 can display the 1st information, using a graphic effect. The 1st information can include an image and/or a letter. The 1st information can be expressed using a screen previously stored in the electronic device 200, a screen provided in a location related with context, a screen provided in a device related with the context, and/or a screen corresponding to the search result of the electronic device 200 in relation with the context.

In operation 330, the electronic device 200 can display 2nd information in the 2nd region 220. According to one example embodiment of the present disclosure, the 2nd information can be information for expressing a user's intention. According to another example embodiment of the present disclosure, the 2nd information can be information about a service provided in relation with the current contextual information. According to a further example embodiment of the present disclosure, the 2nd information can be information for controlling a currently coupled device.

After displaying the 1st information and the 2nd information, in operation 340, when an input is sensed, the electronic device 200 can perform an operation designated by combining the 1st information and the 2nd information. Here, the input can include a touch input, and/or an input that uses a physical button of the electronic device 200. The touch input can include an input through a drag input from the 1st region 210 to the 2nd region 220, a drag input from the 2nd region 220 to the 1st region 210, a touch input in the 2nd region 220, or a touch input on a specific portion of the screen of the electronic device 200. The input that uses the physical button of the electronic device 200 can include an input through a dial of the electronic device 200. Here, the designated operation can be determined according to the 2nd information displayed in the 2nd region 220. The operation designated by combining the 1st information and the 2nd information can include an operation of sharing contextual information, an operation of transmitting a user's intention on the contextual information, an operation of providing a service coupled with context, and/or an operation of controlling a coupled device.

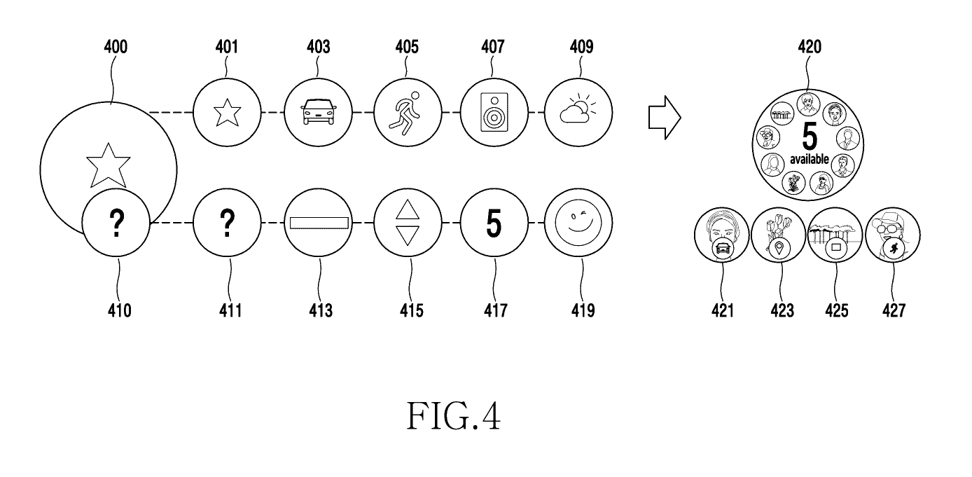

FIG. 4 is a diagram illustrating an example of a screen for providing information in an electronic device according to various example embodiments of the present disclosure.

FIG. 4 illustrates an example of information displayed in a 1st region 400 and a 2nd region 410. In case where the electronic device 200 displays the 1st information in operation 320 of FIG. 3, the information displayed in the 1st region 400 of the electronic device 200 can include service information 401, activity information 403, movement information 405, device information 407, environment information 409, etc. Information displayed in the 2nd region 410 of the electronic device 200 when the electronic device 200 displays the 2nd information in operation 330 of FIG. 3 can include information 411 asking about an intention, information 413 representing obstruction prohibition, control information 415, information 417 about a numeral such as time, the number, etc., information 419 representing an emotion, etc.

In case where the electronic device 200 performs the operation designated by combining the 1st information and the 2nd information in operation 340 of FIG. 3, the information displayed in the 1st region 400 and the 2nd region 410 of FIG. 4 can be combined and transmitted to an external device or another user. For example, in case where the electronic device 200 senses an input, after the electronic device 200 displays a screen 420 for selecting a counterpart to which the 1st information and the 2nd information will be transmitted, the electronic device 200 can transmit information 421, 423, 425 or 427 that is a combination of the 1st information and the 2nd information, to the selected counterpart.

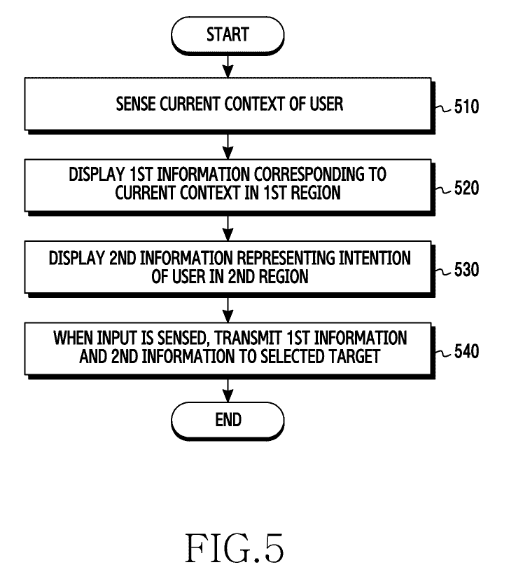

FIG. 5 is a flowchart illustrating an example operation of sharing information in an electronic device according to various example embodiments of the present disclosure.

As illustrated in FIG. 3, the electronic device 200 can provide information to the user of the electronic device 200 or the external. The information provided when providing the information to the user of the electronic device 200 or the external can be information representing a user's intention.

In operation 510, the electronic device 200 can sense current contextual information like operation 310 of FIG. 3. In operation 520, the electronic device 200 can display 1st information that is information corresponding to the current contextual information, in the 1st region 210 of the screen of the electronic device 200, like operation 320 of FIG. 3. In operation 530, the electronic device 200 can display 2nd information representing a user's intention. According to one example embodiment of the present disclosure, the 2nd information can be information for expressing a user's intention. For example, the 2nd information can include information for sharing current context and/or information for representing a user's emotion. In operation 540, the electronic device 200 can sense an input and provide another user with information that is a combination of the 1st information and the 2nd information. Here, the input can include a 1st input and a 2nd input. The 1st input can include an input selecting the 2nd information, and the 2nd input can include an input selecting a target to which information will be transmitted. Here, an input method can include a touch input method, and/or an input method making use of a physical button of the electronic device 200. The touch input method can include an input method through a drag input from the 1st region 210 to the 2nd region 220, an input method through a drag input from the 2nd region 220 to the 1st region 210, a touch input method on the 2nd region 220, or a touch input method on a specific portion of the screen of the electronic device 200. The input method using the physical button of the electronic device 200 can include an input method through a dial of the electronic device 200. If the 1st and 2nd inputs are sensed, the electronic device 200 can transmit the information combining the 1st information and the 2nd information to another user, thereby sharing the current context and the user's emotion or intention with the another user.

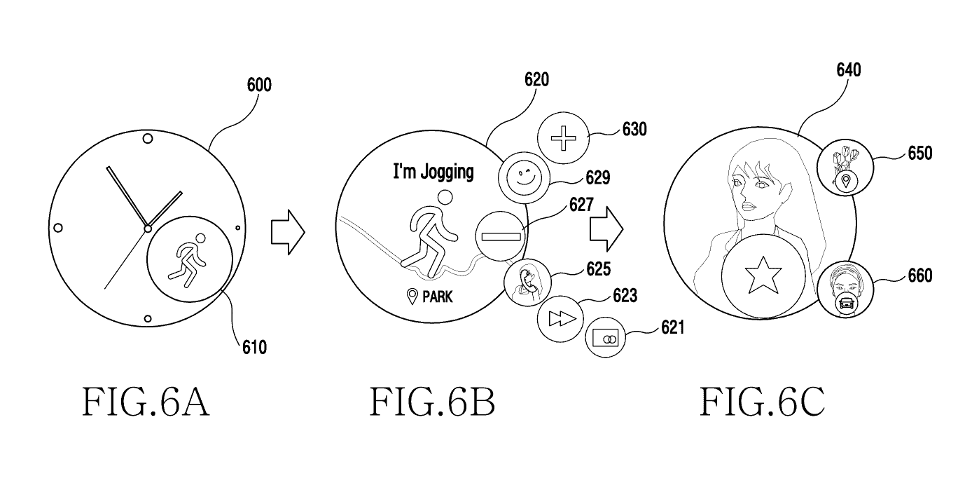

FIGS. 6A, 6B and 6C are diagrams illustrating an example of sharing information in an electronic device in accordance with various example embodiments of the present disclosure.

Referring to FIG. 6A, in case where the electronic device 200 senses specific contextual information in the middle of displaying a basic screen 600 in the 1st region 210, the electronic device 200 can display information 620 about a specific context in the 2nd region 220. FIG. 6A can be a screen displayed as sensing the contextual information in operation 510 of FIG. 5.

Referring to FIG. 6B, the electronic device 200 can include 1st information 620 and 2nd information 621, 623, 625, 627 and 629. The 1st information 620 can be information displayed according to operation 520 of FIG. 5, and the 2nd information 621, 623, 625, 627 and 629 can be information displayed according to operation 530 of FIG. 5. Here, the drawing illustrates the 2nd information 621, 623, 625, 627 and 629, but additional 2nd information can be displayed using an icon 630 for adding 2nd information.

Referring to FIG. 6C, the electronic device 200 can transmit screens 640, 650 and 660 combining the 1st information and the 2nd information to another user. The screens 640, 650 and 660 of FIG. 6C can be screens combining the 1st information and the 2nd information provided according to operation 540 of FIG. 5.

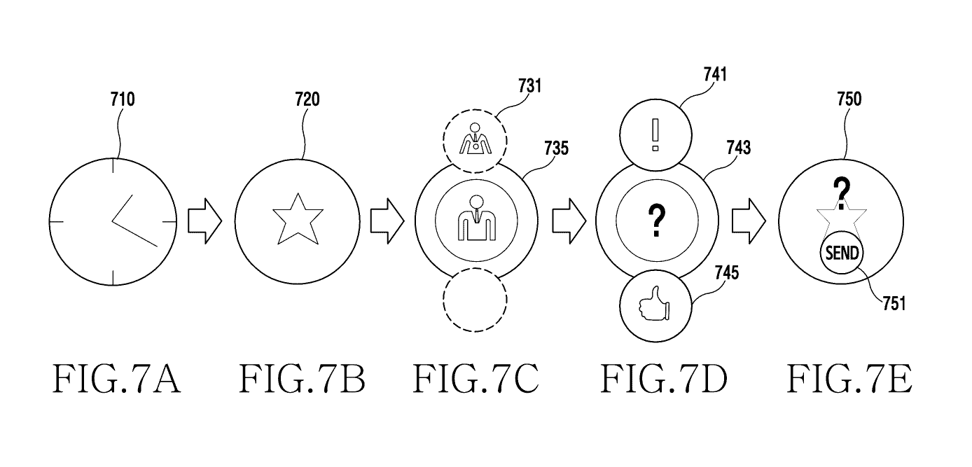

FIGS. 7A, 7B, 7C, 7D and 7E are diagrams illustrating an example of a screen displayed in an electronic device in accordance with an operation of sharing information in FIG. 5.

FIG. 7A illustrates an example of a case in which the electronic device 200 is displaying a basic screen 710 in the 1st region 210. FIG. 7A can be an example of a screen before sensing the current contextual information in operation 510 of FIG. 5. Referring to FIG. 7A, the electronic device 200 can display the basic screen 710, before sensing specific context. FIG. 7A illustrates a screen displaying a clock as an example of the basic screen 710, but this is an example for helping a description of the disclosure, and the basic screen 710 can be a screen designated to the electronic device 200 or a screen designated by the user, as well as the clock displaying.

FIG. 7B illustrates an example of a screen 720 on which the electronic device 200 is displaying 1st information. FIG. 7B can be an example of a screen displaying the 1st information in operation 520 of FIG. 5. FIG. 7B illustrates an example of a screen when a user is now in a coffee shop, but this is an example for helping a description of the disclosure, and the screen displaying the 1st information can be a screen capable of showing a location in which the electronic device 200 is located now.

FIG. 7C illustrates an example of a screen for selecting, by the electronic device 200, a counterpart to which 1st information and 2nd information will be provided. FIG. 7C can be an example of a screen for designating a target in order to transmit the 1st information and the 2nd information to the designated target in operation 540 of FIG. 5. In FIG. 5, operation 540 is performed after operation 530, but the order of operation 530 and operation 540 can be changed according to an example embodiment. The user of the electronic device 200 can select screens 731 and/or 735 displaying users displayed in the electronic device 200, in order to select the counterpart to which the 1st information and the 2nd information will be provided. The screens 731 and/or 735 displaying the users can be displayed based on a list of counterparts previously stored or a list of counterparts that the electronic device 200 provides according to context.

FIG. 7D illustrates examples of screens 741, 743 and/or 745 on which the electronic device 200 is displaying the 2nd information. FIG. 7D can be an example of a screen displaying the 2nd information in operation 530 of FIG. 5. The user can select a screen showing at least one or more intentions among the displayed screens 741, 743 and/or 745, and transmit the selected screen to the counterpart.

FIG. 7E illustrates an example of a screen 750 for transmitting, by the electronic device 200, a screen combining the 1st information and the 2nd information. FIG. 7(e) can be an example of a screen that is displayed to transmit the 1st information and the 2nd information to the designated target in operation 540 of FIG. 5. If the screen 750 combining the 1st information and the 2nd information is displayed, the user can touch a screen region 751 for transmission or perform a drag input, thereby transmitting the screen 750 combining the 1st information and the 2nd information to the designated target 731 or 735.

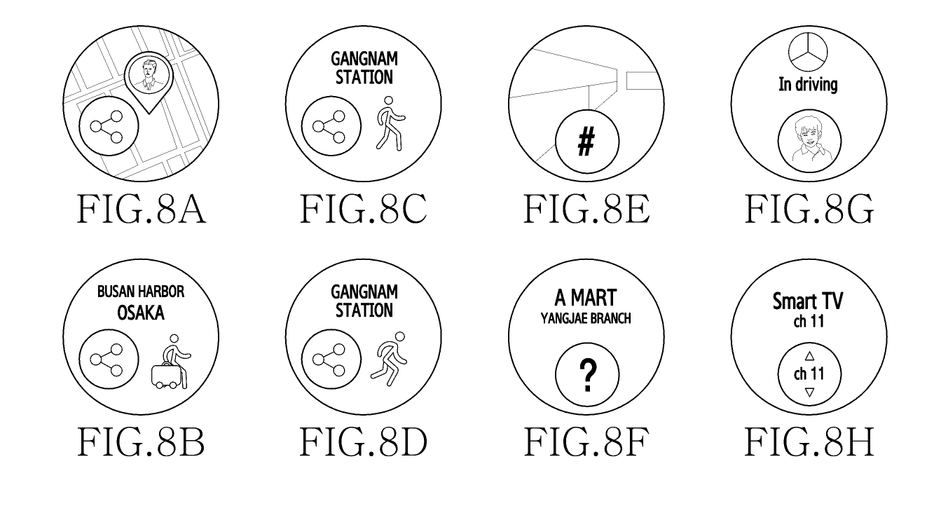

FIGS. 8A, 8B, 8C, 8D, 8E, 8F and 8H are diagrams illustrating an example of user contextual information displayed in an electronic device according to various example embodiments of the present disclosure.

FIG. 8A to FIG. 8H are screens for, after sensing contextual information, displaying the sensed contextual information in accordance with various example embodiments. The displayed screens can be screens corresponding to a location, a movement of a user, a beacon installed in a place, and/or a device. In a method of sensing the contextual information in the electronic device 200, for example, the electronic device 200 can sense an absolute location of the user through a GPS and/or a base station, or sense location information of the user through WiFi coupling, in order to sense contextual information about a location. For another example, to sense contextual information about a service in use, the electronic device 200 can sense a currently located shop name through beacon coupling, or sense a service through payment information of a credit card of the user. For further example, to sense contextual information about an activity, the electronic device 200 can sense the contextual information about the activity through an application that is being executed in the electronic device 200, or sense the contextual information about the activity through an acceleration sensor of the electronic device 200, or sense the contextual information by a coupled external device as well, or sense current context through a movement speed (for example, in-flight, being moving by car, and/or being riding a bike) as well.

According to one example embodiment of the present disclosure, contextual information can be displayed in the 1st region 210 or 2nd region 220 of the screen of the electronic device 220. In case where one or more current context are sensed, the contextual information can be displayed according to designated priority order. The priority order can be, for example, determined according to order that the user previously designates, the latest sensed order, etc. Also, regarding the contextual information, a plurality of pieces of contextual information can be displayed on the screen in accordance with setting as well.

FIG. 8A and FIG. 8B illustrate examples of a screen displayed in case where contextual information about a location is sensed. To sense location information, the electronic device 200 can use information received from a GPS and/or base station, and/or Wireless Fidelity (WiFi) information. Referring to FIG. 8(a), the electronic device 200 can display the contextual information about the location. For example, the electronic device 200 can display a screen of sensing a current location of the electronic device 200 or the user of the electronic device 200 and displaying the sensed location on a map. Here, the electronic device 200 can display a magnified map or place name of the sensed location. Referring to FIG. 8B, after searching the contextual information about the location, the electronic device 200 can display an image corresponding to the searched location. For example, the electronic device 200 can sense a location of the electronic device 200 or the user of the electronic device 200, and acquire information about a place name of the sensed location and then, display an image searched by the acquired place name.

FIG. 8C and FIG. 8D illustrate examples of a screen displayed in case where contextual information about a location and a movement of a user are sensed. To sense the movement of the user, the electronic device 200 can use a wearable activity tracker. Referring to FIG. 8C and 8D, the electronic device 200 can display current location information and a current user's movement state. For example, the electronic device 200 can display the movement of the user such as walking, running, bike riding, swimming, sleeping, standing up, sitting down, etc. in the form of a pictogram. Also, the electronic device 200 can display a movement speed on a screen, using an animation effect as well. FIG. 8C illustrates an example of a screen capable of being displayed in case where the electronic device 200 senses a specific place and determines that the user of the electronic device 200 is walking. FIG. 8D illustrates an example of a screen capable of being displayed in case where the electronic device 200 senses a specific place and determines that the user of the electronic device 200 is running

FIG. 8E and FIG. 8F illustrate examples of a screen displayed in case where information about a service coupled to current context is sensed. To sense the coupled service information, the electronic device 200 can use a Bluetooth Low Energy (BLE) beacon and/or WiFi. Referring to FIG. 8E and 8F, the electronic device 200 can display a state of a currently coupled service. For example, the electronic device 200 can display information about a specific shop in which the user is located. In FIG. 8E, in case where a location in which the electronic device 200 is located is a restaurant, the electronic device 200 can search information about the restaurant and display the searched information on the screen, or display information received from the restaurant on the screen. Referring to FIG. 8F, in case where the location in which the electronic device 200 is located is a shopping center, the electronic device 200 can search information about the shopping center and display the searched information on the screen, or display information received from the shopping center on the screen.

FIG. 8G and FIG. 8H illustrate examples of a screen displayed in case where information about a device coupled to current context is sensed. To sense the coupled device information, the electronic device 200 can use Bluetooth and/or WiFi. Referring to FIG. 8G and 8H, the electronic device 200 can display a state of a currently coupled device. For example, the electronic device 200 can display information about a device coupled with the electronic device 200. In FIG. 8G in case where the electronic device 200 has been coupled with a car or the user of the electronic device 200 has now got in the car, the electronic device 200 can search information about the car and display the searched information on the screen, or display information received from the car on the screen. Referring to FIG. 8H, in case where the electronic device 200 has been coupled with a TV, the electronic device 200 can search information about the TV and display the searched information on the screen, or display information received from the TV on the screen.

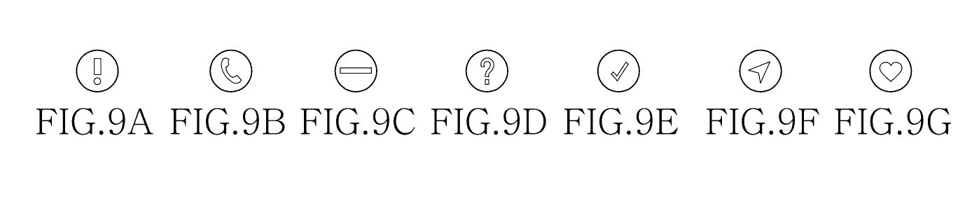

FIGS. 9A, 9B, 9C, 9D, 9E, 9F and 9G are diagrams illustrating an example of user intention information displayed in an electronic device according to various example embodiments of the present disclosure.

FIG. 9A to FIG. 9G illustrate examples of icons displayed to display intention information in accordance with various example embodiments. FIG. 9A to FIG. 9G are screens displaying the intention information for displaying user's intentions in accordance with various example embodiments. The displayed intention information can be screens corresponding to sharing of an emotion or context, device control, and/or service coupling. The intention information can include information about an emotion of the user of the electronic device 200. To figure out the information about the emotion, the electronic device 200 can figure out the emotion through a heart beat, electrocardiography (ECG) and/or electroencephalogram (ECG), or figure out the emotion through a voice tone and/or a facial expression, or figure out the emotion of the user through analyzing of a text of an outgoing message and a search keyword.

According to an example embodiment of the present disclosure, the intention information can be displayed in the 1st region 210 or 2nd region 220 of the screen of the electronic device 220. In case where one or more pieces of intention information are now sensed, the intention information can be displayed according to designated priority order. The priority order can be, for example, determined according to order that the user previously designates, the latest sensed order, etc. Also, regarding the intention information, a plurality of pieces of intention information can be displayed on the screen in accordance with setting as well. The user of the electronic device 200 can display the emotion of the user, by using an icon for displaying the intention information. Regarding information for displaying the intention information, a plurality of pieces of information can be displayed on the screen in accordance with setting as well.

The icon displayed in FIG. 9A can be an icon used for expressing an intention of asking about a counterpart's state or current context. The icon displayed in FIG. 9A can be used to express the intention that the user of the electronic device 200 tries poking a counterpart, or the intention that “I am now in this context. How about you?”. The icon displayed in FIG. 9A can be displayed as the text “what's up?” or “Poke” on the screen, or can be displayed together with the text.

The icon displayed in FIG. 9B can be an icon used for expressing an intention of asking for a contact to a counterpart. The icon displayed in FIG. 9B can be displayed as the text “call me” on the screen, or can be displayed together with the text.

The icon displayed in FIG. 9C can be an icon used for expressing, by the user, an intention of asking for obstruction prohibition. The icon displayed in FIG. 9C can be used for expressing, by the user of the electronic device 200, the intention that he/she is now busy, or the intention that please do not disturb. The icon displayed in FIG. 9C can be displayed as the text “Do not disturb” or “Busy”, or can be displayed together with the text.

The icon displayed in FIG. 9D can be an icon used for expressing an intention of asking for a help. The icon displayed in FIG. 9D can be used for expressing, bythe user of the electronic device 200, the intention that he/she needs a help in current context. The icon displayed in FIG. 9D can be displayed as the text “Help me”, or can be displayed together with the text.

The icon displayed in FIG. 9E can be an icon used for expressing an intention of asking about a repeated or promised question. The icon displayed in FIG. 9E can be used for expressing, by the user of the electronic device 200, an intention for expressing the repeated or promised question to an already acquainted individual, or the intention that “Isn't there anything needed?” The icon displayed in FIG. 9E can be displayed as the text “Anything you need?”, or can be displayed together with the text.

The icon displayed in FIG. 9F can be an icon used for expressing an intention of inviting a counterpart. The icon displayed in FIG. 9F can be used for expressing, by the user of the electronic device 200, an intention for inviting the counterpart to a current location of the user or inviting the counterpart to the current context of the user. The icon displayed in FIG. 9F can be displayed as the text “Will you join us?”, or can be displayed together with the text.

The icon displayed in FIG. 9G can be an icon used for expressing an intention for sharing an emotion about current context with a counterpart. The icon displayed in FIG. 9G can be used for expressing, by the user of the electronic device 200, an intention for sharing current satisfactory context to the counterpart. The icon displayed in FIG. 9GS can be displayed as the text “I love this”, or can be displayed together with the text.

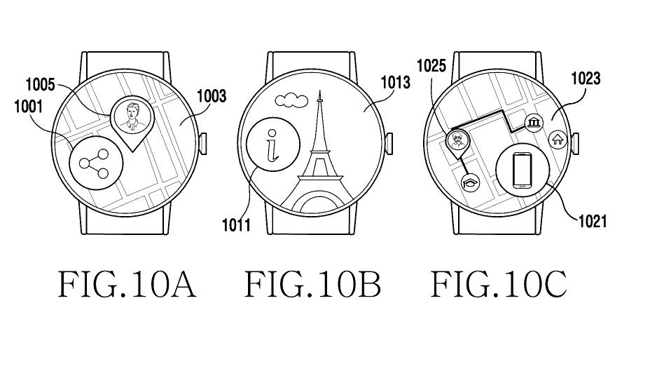

FIGS. 10A, 10B and 10C are diagrams illustrating an example of a screen for providing location information among contextual information according to various example embodiments of the present disclosure.

Referring to FIG. 10A, the electronic device 200 can use a map screen in order to provide contextual information about a location to the user or a counterpart that the user selects. According to an example embodiment of the present disclosure, the electronic device 200 can display a position of a location where the electronic device 200 or the user of the electronic device 200 is located, in the 1st region 210 on a map. The electronic device 200 can display a portion 1005 where the electronic device 200 or the user of the electronic device 200 is located, in the 1st region 210, together with map displaying 1003. The electronic device 200 can transmit displayed location information to the selected counterpart. To transmit the information, the electronic device 200 can display an icon 1001 for sharing, in the 2nd region 220. According to an example embodiment of the present disclosure, in case where the electronic device 200 senses a touch in the 2nd region 220, the electronic device 200 can transmit a screen displayed in the 1st region 210, to the selected counterpart.

Referring to FIG. 10B, the electronic device 200 can use an image of a location in order to provide contextual information about the corresponding location. According to an example embodiment of the present disclosure, the electronic device 200 can display a feature of a position of a location where the electronic device 200 or the user of the electronic device 200 is located, as an image 1013, in the 1st region 210. The electronic device 200 can display a tourist resort being in a corresponding location, a landmark, a feature of the corresponding location, etc., as the image 1013, in the 1st region 210. The image 1013 can be any one of an image received from an external server, an image stored in the electronic device 200, or a searched image. By using the image 1013, the electronic device 200 can display on the screen of the electronic device 200. Also, to provide information of a corresponding location, the electronic device 200 can display an icon 1011 for information provision, in the 2nd region 220. According to an example embodiment of the present disclosure, in case where the electronic device 200 senses a touch in the 2nd region 220, the electronic device 200 can display a screen providing information about a location displayed in the 1st region 210.

Referring to FIG. 10C, after receiving contextual information about a location of another user, the electronic device 200 can display a map screen showing the received contextual information. According to an example embodiment of the present disclosure, the electronic device 200 can display a position of a location where another user or an electronic device of the another user is located, in the 1st region 210 on a map 1023. The electronic device 200 can display a portion 1025 where the another user or the electronic device of the another user is located, in the 1st region 210, together with the map displaying 1023. The user of the electronic device 200 can figure out location information of the another user and accordingly to this, can check a path of the another user. According to an example embodiment of the present disclosure, the electronic device 200 can display a location of the another user in the 1st region 210, and display an icon 1021 for performing communication with the another user in the 2nd region 220. In case where the electronic device 200 senses a touch in the 2nd region 220, the electronic device 200 can execute a walkie-talkie function and enable the user of the electronic device 200 to perform communication with the another user.

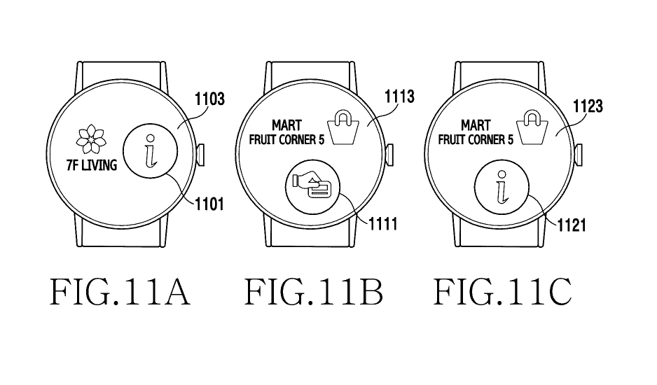

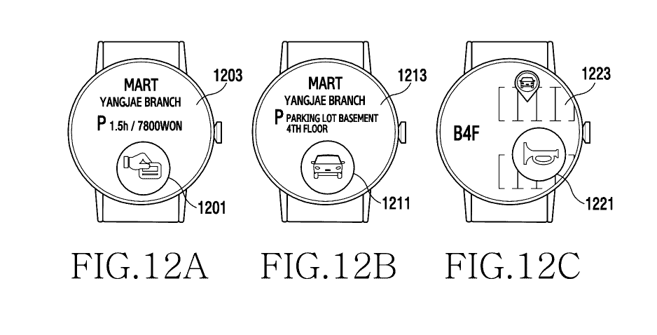

FIGS. 11A, 11B, 11C, 12A, 12B and 12C are diagrams illustrating examples of a screen for, when an electronic device is located in a specific place, providing information about the specific place among contextual information according to various example embodiments of the present disclosure.

Referring to FIG. 11A, the electronic device 200 can display a screen for providing information about a service. According to an example embodiment of the present disclosure, the electronic device 200 can display information 1103 about a position of a location where the electronic device 200 or the user of the electronic device 200 is located, in the 1st region 210. If the location where the electronic device 200 or the user of the electronic device 200 is located is a shop, the electronic device 200 can display an image received from the shop or an image searched for the shop, in the 1st region 210. For example, in case where the electronic device 200 or the user of the electronic device 200 is now located in a department store, the electronic device 200 can display an image related with the department store and floor information of the department store. According to another example embodiment, the electronic device 200 can display an image 1101 related with a service now in use, in the 1st region 210 as well. The electronic device 200 can provide the displayed information about the location to the user. To transmit the information, the electronic device 200 can display an icon 1103 for information provision in the 2nd region 220. According to an example embodiment of the present disclosure, in case where the electronic device 200 senses a touch in the 2nd region 220, the electronic device 200 can display detailed information about a current location.

Referring to FIG. 11B, in case where a location where the electronic device 200 or the user of the electronic device 200 is located is a shop, the electronic device 200 can display an image 1113 of the shop in the 1st region 210. According to an example embodiment of the present disclosure, the electronic device 200 can display payment information 1111 about the shop displayed in the 1st region 210, in the 2nd region 220. The payment information 1111 can include information that the user of the electronic device 200 is paying in the shop displayed in the 1st region 210, or include payment discount and/or point information available in the shop. In case where the electronic device 200 senses a touch in the 2nd region 220, the electronic device 200 can display the payment information on the screen. According to another example embodiment, as illustrated in FIG. 11C, the electronic device 200 can display an image 1123 of the shop in the 1st region 210, and display an icon 1121 for providing information about the shop in the 2nd region 220.

Referring to FIG. 12A, in case where a location where the electronic device 200 or the user of the electronic device 200 is located is a parking lot, the electronic device 200 can display a screen 1203 including an image of a shop and information about the parking lot, in the 1st region 210. For example, in case where the location where the electronic device 200 or the user of the electronic device 200 is located is a parking lot of a shop, the electronic device 200 can display time staying in the parking lot, a parking fee, etc. According to an example embodiment of the present disclosure, the electronic device 200 can display payment information about the parking lot of the shop displayed in the 1st region 210, in the 2nd region 220. The payment information can include information that the user of the electronic device 200 is paying in the parking lot of the shop displayed in the 1st region 210, or include information for making payment using the electronic device 200. In case where the electronic device 200 senses a touch in the 2nd region 1201, the electronic device 200 can display payment information on the screen, or execute a payment module of the electronic device 200 as well.

Referring to FIG. 12B, in case where a location where the electronic device 200 or the user of the electronic device 200 is located is a parking lot of a shop, the electronic device 200 can display a screen 1213 including an image of the shop and information about a position of the parking lot, in the 1st region 210. For example, in case where the location where the electronic device 200 or the user of the electronic device 200 is located is the parking lot of the shop, the electronic device 200 can display a floor number of the parking lot together with an image of the shop. According to one example embodiment of the present disclosure, in case where the electronic device 200 or the user of the electronic device 200 enters the parking lot, the electronic device 200 can display an icon 1211 for providing location information of a car, in the 2nd region 220. In case where the electronic device 200 senses a touch in the 2nd region 220, the electronic device 200 can provide car location information of the user of the electronic device 200.

Referring to FIG. 12C, in case where a location where the electronic device 200 or the user of the electronic device 200 is located is a parking lot of a shop, the electronic device 200 can display information of a parked car on a parking-lot map image in the 1st region 210. For example, in case where the location where the electronic device 200 or the user of the electronic device 200 is located is the parking lot of the shop, the electronic device 200 can display a map screen 1223 of the parking lot, a floor number of the parking lot, and/or a location of a car that the user parks, on a map. According to one example embodiment of the present disclosure, the electronic device 200 can display an icon 1221 for providing location information of the parked car, in the 2nd region 220. In case where the electronic device 200 senses a touch in the 2nd region 220, the electronic device 200 can transmit a signal to beep a horn of the parked car, or display detailed information of the parked location on the screen.

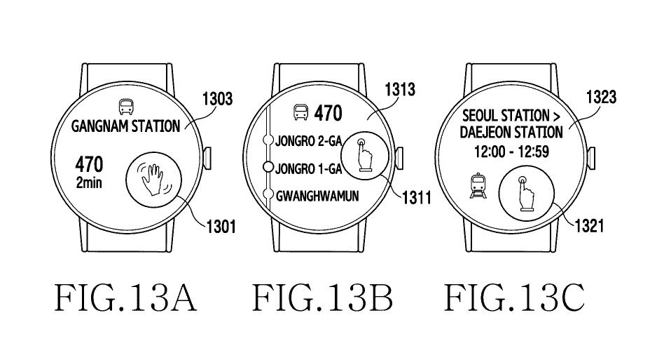

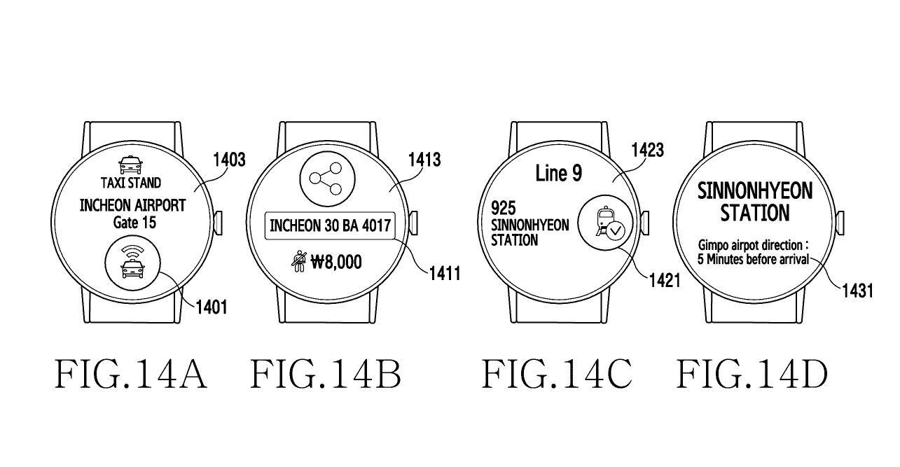

FIGS. 13A, 13B, 13C, 14A, 14B, 14C and 14D are diagrams illustrating examples of a screen for providing information according to a traffic means among contextual information according to various example embodiments of the present disclosure.

Referring to FIG. 13A, in case where a location where the electronic device 200 or the user of the electronic device 200 is located is a stop, the electronic device 200 can display an image 1303 of the stop in the 1st region 210. For example, in case where the location where the electronic device 200 or the user of the electronic device 200 is located is the stop, the electronic device 200 can display a name of the stop, a route number of a bus, a waiting time of the bus, etc. According to one example embodiment of the present disclosure, in case where the electronic device 200 or the user of the electronic device 200 is located in the stop, the electronic device 200 can provide additional information or operation. For example, to provide additional information or an additional operation, the electronic device 200 can display an icon 1301 for displaying a boarding intention in the 2nd region 220. In case where the electronic device 200 senses a touch in the 2nd region 220, the electronic device 200 can transmit intention information that the user of the electronic device 200 will get in a bus or another traffic means. In another example embodiment, in case where the electronic device 200 senses a touch in the 2nd region 220, the electronic device 200 can display intention information that the user of the electronic device 200 will board, using a sound or light as well.

Referring to FIG. 13B, in case where the electronic device 200 or the user of the electronic device 200 has got in a traffic means, the electronic device 200 can display information 1313 about boarding context in the 1st region 210. For example, in case where the electronic device 200 or the user of the electronic device 200 has got in a bus, the electronic device 200 can display a route number of the bus, a route of the bus, a current location of the bus, etc. According to one example embodiment of the present disclosure, in case where current context is context in which the user of the electronic device 200 has got in the traffic means, the electronic device 200 can provide additional information or provide an additional control operation. For example, the electronic device 200 can display an icon 1311 for showing a get-off intention in the 2nd region 220. In case where the electronic device 200 senses a touch in the 2nd region 220, the electronic device 200 can transmit intention information that the user of the electronic device 200 will now get off the traffic means, to the external.

Referring to FIG. 13C, in case where the electronic device 200 or the user of the electronic device 200 has got in a traffic means, the electronic device 200 can display information 1323 about a running plan in the 1st region 210. For example, if the electronic device 200 or the user of the electronic device 200 gets in a reserved train, the electronic device 200 can display a destination, an estimated time of arrival of the destination, remaining hours before the arrival of the destination, a distance to the destination, etc., in the 1st region 210. According to one example embodiment of the present disclosure, in case where current context is context in which the user of the electronic device 200 has got in the traffic means, the electronic device 200 can provide additional information or provide an additional control operation. For example, the electronic device 200 can display an icon 1321 for showing an intention for calling a crew in the 2nd region 220. In case where the electronic device 200 senses a touch in the 2nd region 220, the electronic device 200 can transmit information for calling the crew, to the external.

Referring to FIG. 14A, the electronic device 200 can display an image of a standby context for using a traffic means. For example, in case where a current location is a taxi stop, the electronic device 200 can display location information 1403 about the taxi stop in the 1st region 210. For example, in case where a location where the electronic device 200 or the user of the electronic device 200 is located is the taxi stop, the electronic device 200 can display a name of the stop, a position of the stop, etc. According to one example embodiment of the present disclosure, in case where the electronic device 200 or the user of the electronic device 200 has been located in the taxi stop, the electronic device 200 can provide additional information or operation. For example, to provide additional information or an additional operation, the electronic device 200 can display an icon 1401 for displaying a boarding intention in the 2nd region 220. In case where the electronic device 200 senses a touch in the 2nd region 220, the electronic device 200 can transmit information for calling a taxi by the user of the electronic device 200, to the taxi or a server coupled with the taxi.

Referring to FIG. 14B, the electronic device 200 can display an image of a traffic-means use context. For example, in case where the user of the electronic device 200 has got in a taxi, the electronic device 200 can display information 1411 about taxi running in the 1st region 210. According to one example embodiment, in case where the user of the electronic device 200 has got in the taxi, the electronic device 200 can sense a taxi boarding context and display running information of the taxi that the user of the electronic device 200 has now boarded. The running information of the taxi can include a license plate of the taxi and/or a taxi fee. Particularly, in accordance with an example embodiment of the present disclosure, a background color of an image displayed in accordance with car boarding can be displayed as a color corresponding to the boarded car. According to one example embodiment of the present disclosure, in case where the electronic device 200 or the user of the electronic device 200 has got in the taxi, the electronic device 200 can provide additional information or operation. For example, to provide additional information or an additional operation, the electronic device 200 can display an icon 1413 for transmitting boarding information to another user, in the 2nd region 220. In case where the electronic device 200 senses a touch in the 2nd region 220, the electronic device 200 can transmit information of the taxi that the user of the electronic device 200 has got in, to a selected user.

Referring to FIG. 14C, the electronic device 200 can display an image 1423 of the context that the user of the electronic device 200 enters a subway station, in the 1st region 210. For example, in case where the user of the electronic device 200 has entered the subway station, the electronic device 200 can display information 1423 about subway running in the 1st region 210. According to one example embodiment, in case where the user of the electronic device 200 is waiting to get in the subway, the electronic device 200 can sense a subway running context and display running information of the subway. The running information of the subway can include a route of the subway, current subway station information, an estimated time of entry of the subway, a train number, etc. Particularly, in accordance with an example embodiment of the present disclosure, a background color of the image 1423 displayed in the 1st region 210 can be displayed as a color corresponding to a color of the subway route as well. According to one example embodiment of the present disclosure, in case where the user of the electronic device 200 is waiting to get in the subway, the electronic device 200 can provide additional information or operation. For example, to provide additional information or an additional operation, the electronic device 200 can display an icon 1421 for providing information about subway use, in the 2nd region 220. In case where the electronic device 200 senses a touch in the 2nd region 220, the electronic device 200 can display detailed information about the subway use.

Referring to FIG. 14D, the electronic device 200 can display an image of the context that the user of the electronic device 200 passes through a ticket gate in order to use a subway. For example, in case where the electronic device 200 senses that the user of the electronic device 200 has passed through a ticket gate of a subway station, the electronic device 200 can display information 1431 about subway running According to one example embodiment, in case where the user of the electronic device 200 has passed through the ticket gate of the subway to get in the subway, the electronic device 200 can sense a subway running context and display running information 1431 of the subway. The running information 1431 of the subway can include a subway route, current subway station information, a subway entry time, a subway start time, a train number, etc. Particularly, in accordance with an example embodiment of the present disclosure, a background color of an image for displaying the running information 1431 of the subway can be displayed as a color corresponding to a color of the subway route.

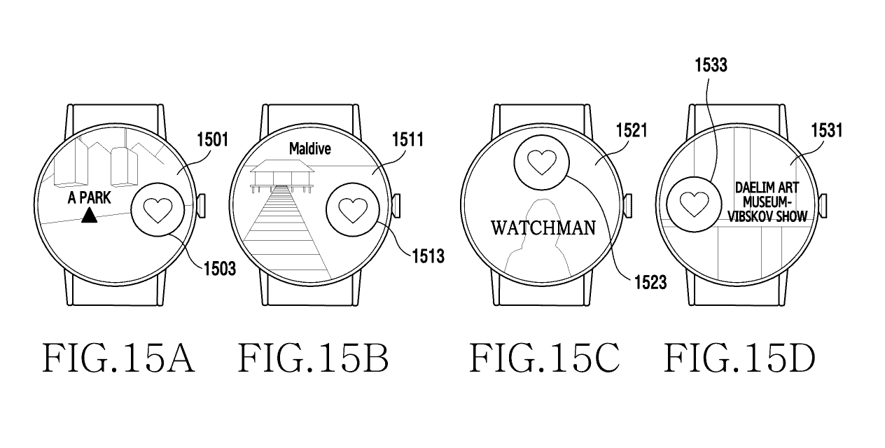

FIGS. 15A, 15B, 15C and 15D are diagrams illustrating an example of a screen for providing user preference information among contextual information according to various example embodiments of the present disclosure. The electronic device 200 can collect content on various context such as a place to which the user of the electronic device 200 goes, a travel destination, a provided service, reading, a restaurant, etc., and provide information about the collected context to the user.

According to one example embodiment of the present disclosure, in case where the user of the electronic device 200 enters a skiing ground, as in FIG. 15A, the electronic device 200 can display contextual information 1501 including an image of the skiing ground and a name of the skiing ground, in the 1st region 210. According to one example embodiment of the present disclosure, in case where the electronic device 200 or the user of the electronic device 200 is located in the skiing ground, the electronic device 200 can provide additional information or operation. For example, the electronic device 200 can display an image 1503 for expressing the intention that the user prefers the skiing ground, in the 2nd region 220. That the user prefers a specific context can be automatically provided by the electronic device 200 through information stored in the electronic device 200, or can be displayed by selecting the intention that the user prefers as well.

According to another example embodiment of the present disclosure, in case where the user of the electronic device 200 is located in a travel destination, as in FIG. 15B, the electronic device 200 can display an image 1511 of the travel destination in the 1st region 210, thereby displaying contextual information. In the 1st region 210, an image of the travel destination and a name of the travel destination can be displayed. According to another example embodiment of the present disclosure, in case where the electronic device 200 or the user of the electronic device 200 is located in the travel destination, the electronic device 200 can provide additional information or operation. For example, the electronic device 200 can display an image 1513 for expressing the intention that the user prefers the travel destination, in the 2nd region 220.

According to a further example embodiment of the present disclosure, in case where the electronic device 200 senses the context that the user of the electronic device 200 is now reading, as in FIG. 15C, the electronic device 200 can display contextual information 1521 including an image of a book that is being now read and a name of the book, in the 1st region 210. Here, the book can include an electronic book (e-book). According to a yet another example embodiment of the present disclosure, in case where the electronic device 200 senses the context that the electronic device 200 or the user of the electronic device 200 is reading, the electronic device 200 can provide additional information or operation. For example, the electronic device 200 can display an image 1523 for expressing the intention that the user prefers a specific book, in the 2nd region 220.

According to a still another example embodiment of the present disclosure, in case where the electronic device 200 senses that the user of the electronic device 200 is located in an art museum, the electronic device 200 can display , as in FIG. 15D, contextual information 1531 including an image of the art museum and a name of the art museum in the 1st region 210. According to a still another example embodiment of the present disclosure, in case where the electronic device 200 or the user of the electronic device 200 is located in the art museum, the electronic device 200 can provide additional information or operation. For example, the electronic device 200 can display an image 1533 for expressing the intention that the user prefers the art museum, in the 2nd region 220.

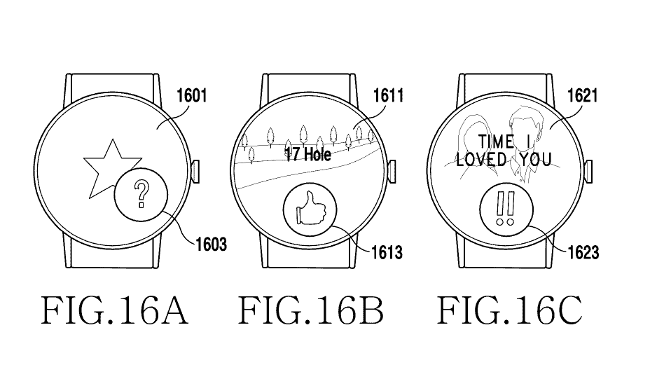

FIGS. 16A, 16B and 16C are diagrams illustrating an example of a screen for providing user intention information according to various example embodiments of the present disclosure.

The electronic device 200 can provide the user with information for forwarding, by the user of the electronic device 200, current context to an acquaintance of the user, and making suggestions and recommendations.

According to one example embodiment of the present disclosure, in case where the user of the electronic device 200 enters a coffee shop, as in FIG. 16A, the electronic device 200 can display an image 1601 of the coffee shop in the 1st region 210, thereby displaying contextual information. According to one example embodiment of the present disclosure, in case where the electronic device 200 or the user of the electronic device 200 is located in the coffee shop, the electronic device 200 can provide additional information or operation. For example, the electronic device 200 can display an image 1603 for expressing the intention that the user prefers the coffee shop, in the 2nd region 220. The information that the user prefers a specific context can be automatically provided by the electronic device 200 through coffee shop information stored in the electronic device 200, or can be displayed by selecting the intention that the user prefers as well.

According to another example embodiment of the present disclosure, in case where the user of the electronic device 200 is located in a golf club, as in FIG. 16B, the electronic device 200 can display an image 1611 of the golf club in the 1st region 210, thereby displaying contextual information. In the 1st region 210, an image of the golf club, a name of the golf club, and a hole number of the golf club can be displayed. According to a further example embodiment of the present disclosure, in case where the electronic device 200 or the user of the electronic device 200 is located in the golf club, the electronic device 200 can provide additional information or operation. For example, the electronic device 200 can display an image 1613 for forwarding, by the user, information about the golf club or the golf game result in the golf club to another user, in the 2nd region 220.

According to a yet another example embodiment of the present disclosure, in case where the electronic device 200 senses the context that the user of the electronic device 200 is now watching a TV, as in FIG. 16C, the electronic device 200 can display contextual information 1621 including an image of a TV program that is being now viewed and a name of the TV program, in the 1st region 210. According to a still another example embodiment of the present disclosure, in case where the electronic device 200 senses the context that the electronic device 200 or the user of the electronic device 200 is watching the TV, the electronic device 200 can provide additional information or operation. For example, the electronic device 200 can display an image 1623 for recommending, by the user, a specific TV program to another user, in the 2nd region 220.

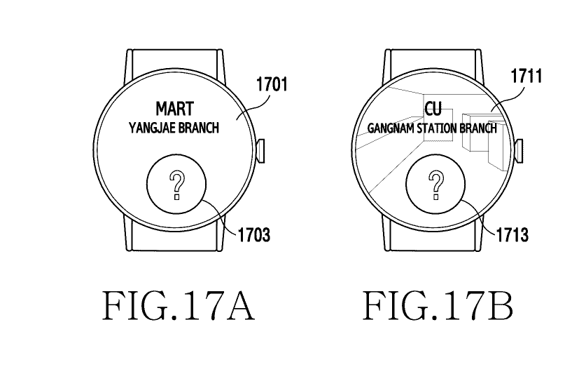

FIGS. 17A and 17B are diagrams illustrating an example of a screen for forwarding a message of a repeated pattern according to various example embodiments of the present disclosure.

The electronic device 200 according to the present disclosure can provide the user with information for forwarding, by the user of the electronic device 200, current context to an acquaintance of the user and forwarding a repeated pattern message of the current context.

According to one example embodiment of the present disclosure, in case where the user of the electronic device 200 enters a shopping mall, as in FIG. 17A, the electronic device 200 can display contextual information 1701 including an image of the shopping mall and a name of the shopping mall, in the 1st region 210. According to one example embodiment of the present disclosure, in case where the electronic device 200 or the user of the electronic device 200 is located in the shopping mall, the electronic device 200 can provide additional information or operation. For example, in case where the user is located in the shopping mall, the electronic device 200 can display an image 1703 for forwarding, by the user, a repeated pattern message with a specific acquaintance, in the 2nd region 220. The user can forward the images displayed in the 1st region 210 and 2nd region 220 of the electronic device 220 to another user, thereby displaying current context and an intention of the current context. According to one example embodiment, to inquire of a counterpart if there is something needed in the shopping mall, the electronic device 200 can transmit a shopping mall image 1701 displayed in the 1st region 210 and a question mark 1703 displayed in the 2nd region 220, to the counterpart.

According to another example embodiment of the present disclosure, in case where the user of the electronic device 200 enters a convenience stall, as in FIG. 17B, the electronic device 200 can display contextual information 1711 including an image of the convenience stall and a name of the convenience stall, in the 1st region 210. According to one example embodiment of the present disclosure, in case where the electronic device 200 or the user of the electronic device 200 has been located in the convenience stall, the electronic device 200 can provide additional information or operation. For example, in case where the user is located in the convenience stall, the electronic device 200 can display an image 1713 for forwarding, by the user, a repeated pattern message with a specific acquaintance, in the 2nd region 220. The user can forward the images displayed in the 1st region 210 and 2nd region 220 of the electronic device 220 to another user, thereby displaying current context and an intention of the current context. According to one example embodiment, to inquire of a counterpart if there is something needed in the convenience stall, the electronic device 200 can transmit a convenience stall image 1711 displayed in the 1st region 210 and a question mark 1713 displayed in the 2nd region 220, to the counterpart.

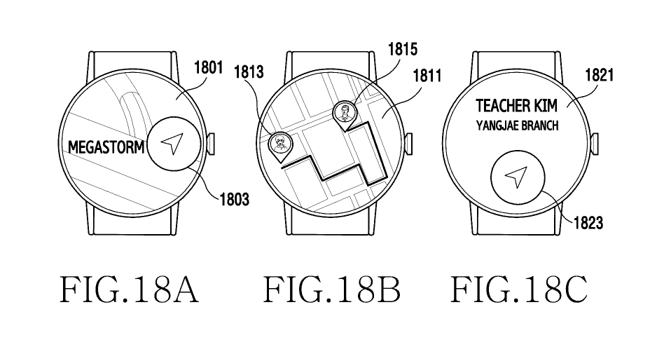

FIGS. 18A, 18B and 18C are diagrams illustrating an example of a screen for forwarding user proposal information according to various example embodiments of the present disclosure.

The user of the electronic device 200 according to the present disclosure can provide information for proposing that another user join a current location, based on information about the current location, using the electronic device 200.

According to one example embodiment of the present disclosure, in case where the user of the electronic device 200 is located in a specific facility of a theme park, as in FIG. 18A, the electronic device 200 can display contextual information 1801 including an image of the specific facility of the theme park and a name of the specific facility of the theme park, in the 1st region 210. According to one example embodiment of the present disclosure, in case where the electronic device 200 or the user of the electronic device 200 has been located in the specific facility of the theme park, the electronic device 200 can provide additional information or operation. For example, in case where the user is located in the specific facility of the theme park, the electronic device 200 can display an image 1803 for proposing that another user join the specific facility of the theme park, in the 2nd region 220.

According to another example embodiment of the present disclosure, in case where the user of the electronic device 200 is located in the specific facility of the theme park, as in FIG. 18B, the electronic device 200 can display a map 1811 of the theme park, a current location 1813 of the user, and a location 1815 of another counterpart, in the 1st region 210. According to a further example embodiment of the present disclosure, in case where the electronic device 200 or the user of the electronic device 200 is located in the specific facility of the theme park, the electronic device 200 can display a theme park map, a current location 1813 of the user, and a location 1815 of another counterpart, and display a path between the current location 1813 of the user and the location 1815 of the another counterpart. By displaying the map information 1811, the current location 1813 of the user, the location 1815 of the another user, and the path between the users in the 1st region 210, the user of the electronic device 200 can display the intention of making the another user come to the current location of the user, to the another user.

According to a yet another example embodiment of the present disclosure, in case where the user of the electronic device 200 is located in a restaurant, as in FIG. 18C, the electronic device 200 can display a screen 1821 including an image of the restaurant, a name of the restaurant, and information of the restaurant, in the 1st region 210. According to one example embodiment of the present disclosure, in case where the electronic device 200 or the user of the electronic device 200 has been located in the restaurant, the electronic device 200 can provide additional information or operation. For example, in case where the user is located in the restaurant, the electronic device 200 can display an image 1823 for expressing to another user the intention that let's have a meal in the restaurant, in the 2nd region 220. The electronic device 200 can transmit the image 1823 to the another user.

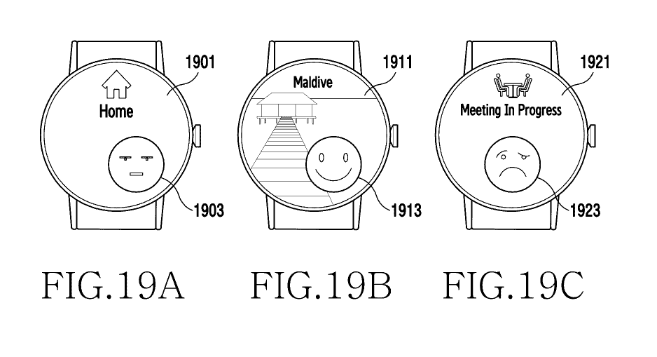

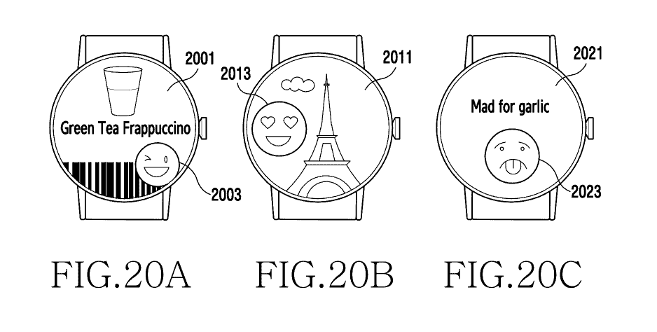

FIGS. 19A, 19B, 19C, 20A, 20B and 20C are diagrams illustrating examples of a screen for providing emotion information according to user's context according to various example embodiments of the present disclosure.

The electronic device 200 can display a screen for showing the current context of the user of the electronic device 200 and an emotion of the current context.

According to one example embodiment of the present disclosure, in case where the user of the electronic device 200 is at home, as in FIG. 19A, the electronic device 200 can display contextual information 1901 including a home image in the 1st region 210. According to one example embodiment of the present disclosure, in case where the electronic device 200 or the user of the electronic device 200 is at home, the electronic device 200 can provide additional information or operation. For example, the electronic device 200 can display an image 1903 for expressing the intention that the user is now bored, in the 2nd region 220. The user of the electronic device 200 can transmit the home image displayed in the 1st region 210 and the image displayed in the 2nd region 220 to another user, and express the contextual and intention information that the user of the electronic device 200 is now at home and bored.

According to another example embodiment of the present disclosure, in case where the user of the electronic device 200 is at a travel destination, as in FIG. 19B, the electronic device 200 can display contextual information 1911 including an image of the travel destination in the 1st region 210. According to one example embodiment of the present disclosure, in case where the electronic device 200 or the user of the electronic device 200 is at the travel destination, the electronic device 200 can provide additional information or operation. For example, the electronic device 200 can display an image 1913 for expressing the intention that the user is now happy, in the 2nd region 220. The user of the electronic device 200 can transmit the travel destination image 1911 displayed in the 1st region 210 and the image 1913 displayed in the 2nd region 220 to another user, and express the contextual and intention information that the user of the electronic device 200 is now at the travel destination and feels so good now.

According to a further example embodiment of the present disclosure, in case where the user of the electronic device 200 is in conference, as in FIG. 19C, the electronic device 200 can display contextual information 1921 including an image representing being in conference in the 1st region 210. According to one example embodiment of the present disclosure, in case where the electronic device 200 or the user of the electronic device 200 is in conference, the electronic device 200 can provide additional information or operation. For example, the electronic device 200 can display an image 1923 for expressing the intention that the user gets annoyed now, in the 2nd region 220. The user of the electronic device 200 can transmit the image 1921 representing being in conference displayed in the 1st region 210 and the image 1923 displayed in the 2nd region 220 to another user, and express the contextual and intention information that the user of the electronic device 200 is now in conference and gets so annoyed now.

According to a yet another example embodiment of the present disclosure, in case where the user of the electronic device 200 has got a gift from another counterpart, as in FIG. 20A, the electronic device 200 can display contextual information 2001 including an image of the got gift, in the 1st region 210. According to one example embodiment of the present disclosure, in case where the electronic device 200 or the user of the electronic device 200 has got the gift from the counterpart, the electronic device 200 can provide additional information or operation. For example, the electronic device 200 can display an image 2003 for expressing the intention that the user appreciates, in the 2nd region 220. The user of the electronic device 200 can transmit the image 2001 of the gift displayed in the 1st region 210 and the image 2003 displayed in the 2nd region 220 to another user, and express the contextual and intention information that the user of the electronic device 200 now gets the gift and thanks the counterpart.

According to a still another example embodiment of the present disclosure, in case where the user of the electronic device 200 is on travel, as in FIG. 20B, the electronic device 200 can display contextual information 2011 including an image of a travel destination in the 1st region 210. According to one example embodiment of the present disclosure, in case where the electronic device 200 or the user of the electronic device 200 is located in the travel destination, the electronic device 200 can provide additional information or operation. For example, the electronic device 200 can display an image 2013 for expressing the intention that the user loves the travel destination, in the 2nd region 220. The user of the electronic device 200 can transmit the image 2011 of the travel destination in the 1st region 210 and the image 2013 displayed in the 2nd region 220 to another user, and express the contextual and intention information that the user of the electronic device 200 is now in the lovable travel destination.

According to a still another example embodiment of the present disclosure, in case where the user of the electronic device 200 is in a restaurant, as in FIG. 20C, the electronic device 200 can display contextual information 2021 including an image of the restaurant in the 1st region 210. According to one example embodiment of the present disclosure, in case where the electronic device 200 or the user of the electronic device 200 is in the restaurant, the electronic device 200 can provide additional information or operation. For example, the electronic device 200 can display an image 2023 for expressing the intention that the user has a full stomach in the restaurant, in the 2nd region 220. The user of the electronic device 200 can transmit the image 2021 of the restaurant displayed in the 1st region 210 and the image 2023 displayed in the 2nd region 220 to another user, and express the contextual and intention information that the user of the electronic device 200 now has a full stomach in the restaurant.

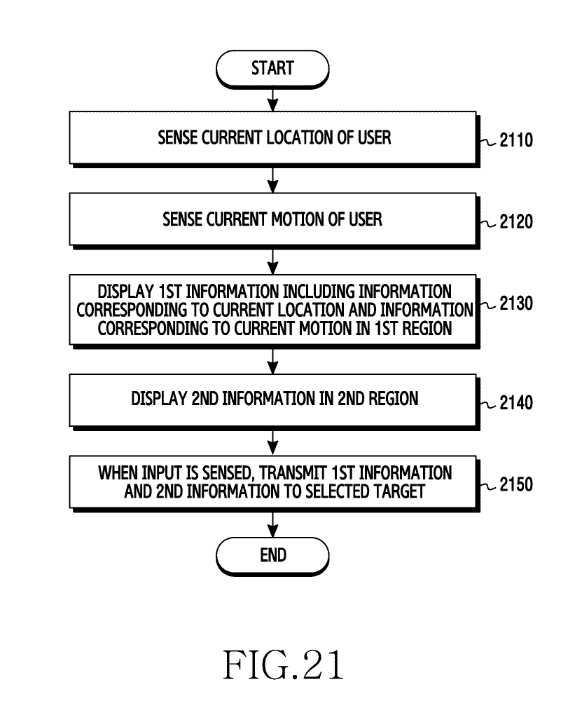

FIG. 21 is a flowchart illustrating an example operation of providing information according to location information and pose information in an electronic device according to various example embodiments of the present disclosure.

According to the present disclosure, the electronic device 200 can display information about context in which the user of the electronic device 200 performs a specific behavior in a specific place. The electronic device 200 can sense a movement of the user, based on the contextual information, and combine the sensed movement and the contextual information and share an immediate state with another user. Referring to FIG. 21, in operation 2110, the electronic device 200 can sense a current location of the user of the electronic device 200. In operation 2120, the electronic device 200 can sense a current motion of the user of the electronic device 200. To sense a motion or speed of the user, the electronic device 200 can use a speed sensor, an acceleration sensor, a gyro sensor, etc. In operation 2130, the electronic device 200 can display 1st information including information corresponding to the current location and information corresponding to the current motion, in the 1st region 210 of the screen of the electronic device 200. Here, the information corresponding to the current location can include an image of the current location, a name of the current location, etc. The information corresponding to the current motion can include information about whether the user takes which pose, whether the motion of the user corresponds to which motion, and corresponds to which state. The information corresponding to the current motion can be displayed in the form of an image or a moving image. In operation 2140, the electronic device 200 can display 2nd information in the 2nd region 220. The 2nd information can include service information, activity information, movement information, device information, environment information, etc., and can include information for showing an intention of the user illustrated in FIG. 9. In operation 2150, in case where an input is sensed, the electronic device 200 can transmit the 1st information and the 2nd information to a selected target. If 1st and 2nd inputs are sensed, the electronic device 200 can transmit information combining the 1st information and the 2nd information to another user, thereby sharing current context and an emotion or intention of the user with the another user.

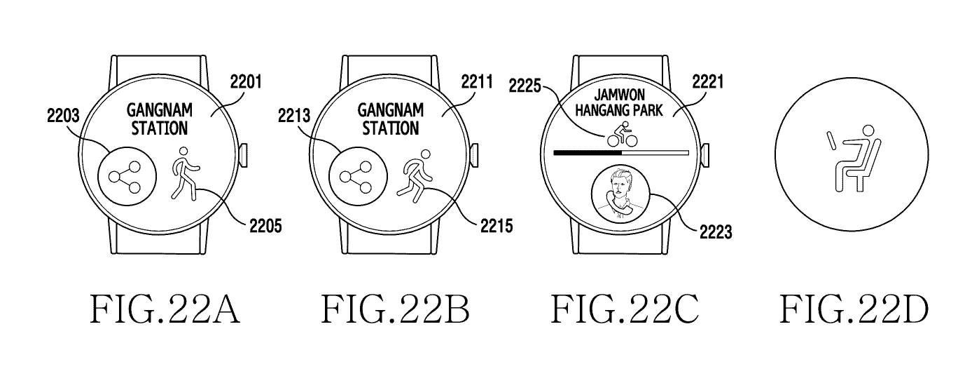

FIGS. 22A, 22B, 22C and 22D are diagrams illustrating an example of a screen for providing information according to location information and pose information in an electronic device according to various example embodiments of the present disclosure.

FIGS. 22A-22D can be an example of a screen provided according to a procedure carried out in FIG. 21. In case where the user of the electronic device 200 is located in a specific place and performs a specific motion in the specific place, the electronic device 200 can display contextual information about the specific place and the specific operation, in the 1st region 210.

According to one example embodiment of the present disclosure, the electronic device 200 can display a current location 2201 or 2211 of the user of the electronic device 200, and a state 2205 in which the user of the electronic device 200 is now walking or a state 2215 in which the user is now running, in the 1st region 210 of FIGS. 22A and 22B. In case where the electronic device 200 senses a touch input in the 2nd region 220, the electronic device 200 can transmit the contextual information displayed in the 1st region 210, to another user.

According to another example embodiment of the present disclosure, the electronic device 200 can display current location information 2221 and current traffic contextual information 2225 in the 1st region 210 of the screen, illustrated in FIG. 22C. Reference numeral 2225 of FIG. 22C illustrates an example when the electronic device 200 senses the motion that the user rides a bike. If the user gets in a traffic means such as a car, an airplane, etc., the electronic device 200 can display an image such as FIG. 22D as well. The electronic device 200 can also display a progress state of a current motion of the user, as well as the motion of the user. For example, the electronic device 200 can sense and display a progressed distance among the whole distance as denoted by reference numeral 2225 of FIG. 22C, as well. In case where the electronic device 200 senses a touch input in the 2nd region 220, the electronic device 200 can provide the contextual information displayed in the 1st region 210, to a counterpart 2223 displayed in the 2nd region 220 as well.

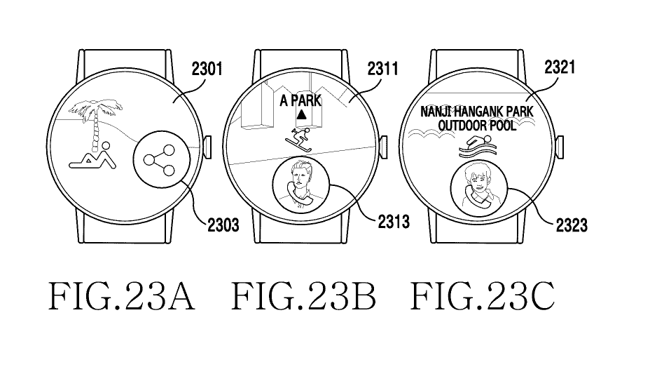

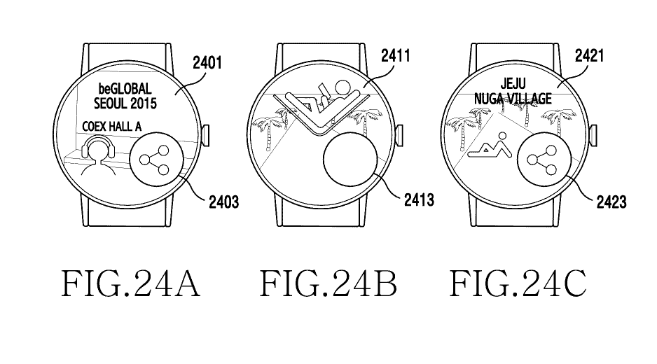

FIGS. 23A, 23B, 23C, 24A, 24B and 24C are diagrams illustrating examples of a screen for providing pose information sensed by location information in an electronic device according to various example embodiments of the present disclosure.

According to the present disclosure, the electronic device 200 can display a current motion of the user of the electronic device 200 expected according to a current location, based on information that the user of the electronic device 200 is located.

According to one example embodiment of the present disclosure, by using contextual information 2301, 2311 and/or 2321 illustrated in FIGS. 23A, 23B, and 23C and contextual information 2401, 2411 and/or 2421 illustrated in FIGS. 24A, 24B and 24C, the electronic device 200 can display images of a place where the user is now located and a motion of the user expected according to a current location. The motion of the user expected according to the current location can be provided by the electronic device 200 on the basis of information stored for a motion that the user of the electronic device 200 frequently executes at a time the user of the electronic device 200 is located in a specific place, or be provided by the electronic device 200 on the basis of motion information corresponding to the specific place received from a server. For example, referring to FIG. 23A, in case where the user of the electronic device 200 is located in a resort, the electronic device 200 can determine a user's expected motion as a motion of being resting, and display an image according to this. For another example, referring to FIG. 23B, in case where the user of the electronic device 200 is located in a skiing ground, the electronic device 200 can determine a user's expected motion as a skiing motion and display an image according to this. For further example, referring to FIG. 23C, in case where the user of the electronic device 200 is located in a swimming pool, the electronic device 200 can determine a user's expected motion as a swimming motion and display an image according to this. For yet another example, referring to FIG. 24Aa), in case where the user of the electronic device 200 is taking part in a conference, the electronic device 200 can determine a user's expected motion as a motion of listening to conference content or a motion of wearing a translator, and display an image according to this. For still another example, referring to FIG. 24B, in case where the user of the electronic device 200 is located in a hotel, the electronic device 200 can determine a user's expected motion as a resting motion and display an image according to this. For still another example, referring to FIG. 24C, in case where the user of the electronic device 200 is located in a pension, the electronic device 200 can determine a user's expected motion as a motion of being resting and display an image according to this.

The electronic device 200 can transmit displayed location information and motion information to another user. For example, in case where an icon displayed in the 2nd region 220 is an icon 2303 of FIG. 23A or an icon 2403 or 2423 of FIG. 24B, the electronic device 200 can transmit the current location information and motion information of the user of the electronic device 200 to the another user. According to another example embodiment, in case where the icon displayed in the 2nd region 220 is an icon 2313 of FIG. 23B or an icon 2323 of FIG. 23C, when the electronic device 200 gets a phone call from the another user, the electronic device 200 can transmit current context to the another user by sensing a touch input in the 2nd region 220. Through this operation, when there is a phone call request from the another user during a specific context, the user can transmit current context to the another user even by a simple motion only. According to a further example embodiment, in case where the icon displayed in the 2nd region 220 is an icon 2413 of FIG. 24B, the electronic device 200 can perform an operation according to a motion that the user sets, as well.

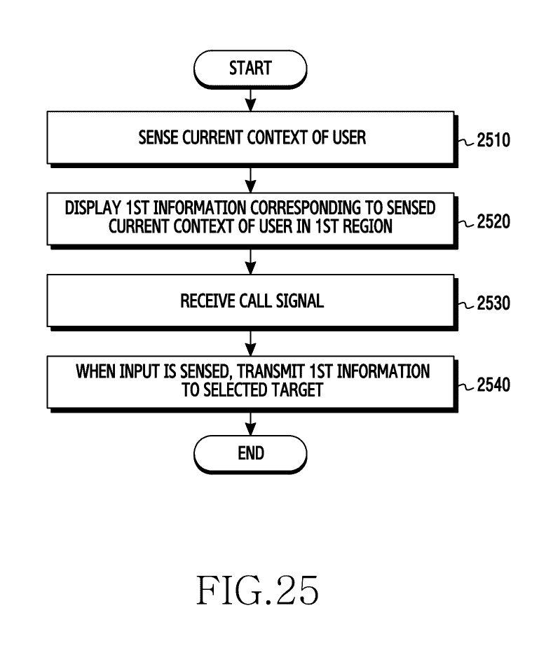

FIG. 25 is a flowchart illustrating an example operation of providing information when receiving a call signal in an electronic device according to various example embodiments of the present disclosure. In case where a phone call/text/message has come to a counterpart, the user of the electronic device 200 can simply and clearly express a current state of the user of the electronic device 200, using the electronic device 200.

In operation 2510, the electronic device 200 can sense current contextual information. The contextual information can include information about a current location of the electronic device 200 or the user of the electronic device 200, a motion thereof, an environment thereof, etc. In operation 2520, the electronic device 200 can display 1st information that is information corresponding to the current contextual information in the 1st region 210 of the screen of the electronic device 200. In operation 2530, the electronic device 200 can receive a call signal from another user. The call signal can include a signal for contacting, by the another user, with the user of the electronic device 200, including a text, a phone call and/or a video call. In operation 2540, in case where an input is sensed, the electronic device 200 can transmit the 1st information to a selected target. Here, the input can include a touch on a portion of the 2nd region 220 of the electronic device 200, a drag input from the 1st region 210 to the 2nd region 220, a drag input from the 2nd region 220 to the 1st region 210, or an input of a scheme preset by the user and/or an input using a physical key of the electronic device 200. In case where an input is sensed, the electronic device 200 can transmit the 1st information that is the information corresponding to the contextual information of the user of the electronic device, to a user who has currently sent a call request to the user of the electronic device 200.

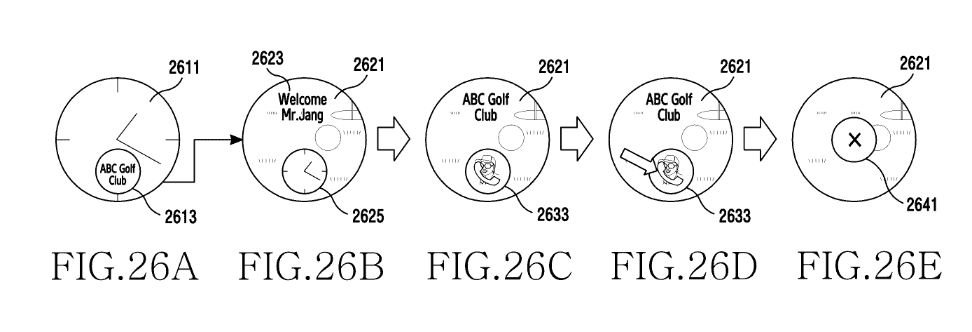

FIGS. 26A, 26B, 26C, 26D and 26E are diagrams illustrating an example of a screen displayed in an electronic device in order to provide information when receiving a call signal in FIG. 25.

FIG. 26A illustrates a basic mode of the electronic device 200. The 1st region 210 of a basic mode screen according to one example embodiment of the present disclosure can include a clock mode 2611. In the drawing, the clock mode 2611 is illustrated, but the 1st region 210 of the basic mode screen can display a screen that the user sets. The 2nd region 220 of the basic mode screen can include contextual information 2613. The contextual information can be selected according to two criterions: location and activity. The location can be determined according to a service, a trade name, and/or an address name. The activity can be determined according to pose and/or context sensing.

FIG. 26B illustrates a screen of sensing, by the electronic device 200, the current context of the user. FIG. 26B can be a screen corresponding to operations 2510 and 2520 of FIG. 25. In case where the electronic device 200 senses that the user is in a specific context, the electronic device 200 can display current contextual information in the 1st region 210 of the electronic device 200. In an example of FIG. 26B, in case where the user of the electronic device 200 is located in a golf club, the electronic device 200 can display an image 2621 related with the golf club in the 1st region 210 of the screen, and display a guide message 2623 to the user. After displaying the image of the golf club in the 1st region 210, the electronic device 200 can display a basic screen 2625 in the 2nd region 220 of the screen. The image displayed in the 2nd region 220 of the screen of the electronic device 200 can be different according to context and/or user's setting.

FIG. 26C illustrates a screen when the electronic device 200 receives a call signal from another user. FIG. 26C can be a screen corresponding to operation 2530 of FIG. 25. In case where the electronic device 200 receives a call from the another user, the electronic device 200 can display current context 2621 in the 1st region 210 of the screen of the electronic device 200, and display an image 2633 that the electronic device 200 has received the call from the another user, in the 2nd region 220.

FIG. 26D illustrates a screen of an operation of sensing an input from the user of the electronic device 200 when the electronic device 200 receives a call signal from another user. FIG. 26D and FIG. 26E can be screens corresponding to operation 2540 of FIG. 25. In case where the electronic device 200 receives a call from the another user, the electronic device 200 can sense an input from the user and perform an operation according to the input. Here, the input can include an input by a touch, a drag, or a physical key. FIG. 26D illustrates an input of sensing a drag from the 1st region 210 to the 2nd input 220 among example embodiments sensing inputs.

FIG. 26E illustrates an example of a screen that is displayed when the electronic device 200 receives an input from the user of the electronic device 200. In case where the electronic device 200 receives a call from another user and senses an input from the user, the electronic device 200 can transmit current contextual information to the user who has sent a call request. For example of FIG. 26, in case where the electronic device 200 receives a call from the another user and senses an input on the user, the electronic device 200 can transmit the image 2621 of the golf club to the another user who has sent a call request. If the user of the electronic device 200 wants to cancel contextual information transmission during the contextual information transmission, the user of the electronic device 200 can cancel the contextual information transmission by performing a touch on a portion 2641. According to another example embodiment of the present disclosure, although not illustrated in the drawing, in case where the electronic device 200 receives the call from the another user, the electronic device 200 can, though not sensing the input of the user, transmit current contextual information to the another user who has sent a call request in accordance with setting as well.

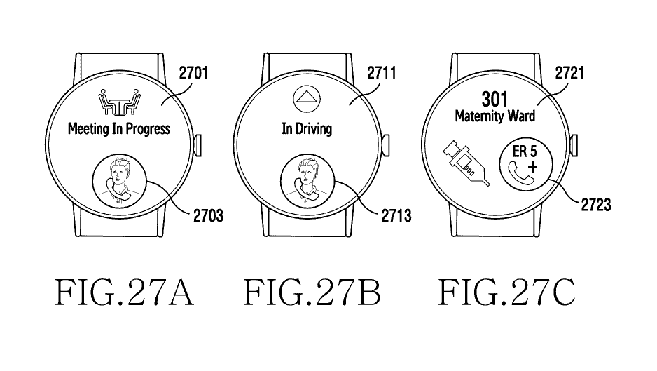

FIG. 27A, 27B, 27C, 28A, 28B, 28C, 28D, 28E and 28F are diagrams illustrating examples of a screen for providing information when receiving a call signal in an electronic device according to various example embodiments of the present disclosure.

According to an example embodiment of the present disclosure, the electronic device 200 can sense current contextual information, and transmit the sensed current contextual information to another user. The user of the electronic device 200 can transmit current contextual information to the another user who has sent a request for a call, thereby transmitting information that the user of the electronic device 200 cannot now respond to the requested call.

Referring to FIGS. 27A, 27B and 27C, the electronic device 200 can display the current context of the user of the electronic device 200 in the 1st region 210 of the screen of the electronic device 200 and, if sensing an input from the user and if it is, though not sensing the input, a preset case, the electronic device 200 can transmit information displayed in the 1st region 210 to a counterpart who has sent a call request. For example, in case where the electronic device 200 senses that the user of the electronic device 200 is now in conference, the electronic device 200 can transmit an image and text 2701 of FIG. 27A to a counterpart 2703 displayed in the 2nd region 220 of the screen. For another example, in case where the electronic device 200 senses that the user of the electronic device 200 is now in driving, the electronic device 200 can transmit an image and text 2711 including a car type, the number of companions, etc. of FIG. 27B, to a counterpart 2713 displayed in the 2nd region 220 of the screen. For further example, in case where the electronic device 200 senses that the user of the electronic device 200 is now in medical treatment, the electronic device 200 can transmit an image and text 2721 of FIG. 27C to a counterpart 2723 displayed in the 2nd region 220 of the screen.

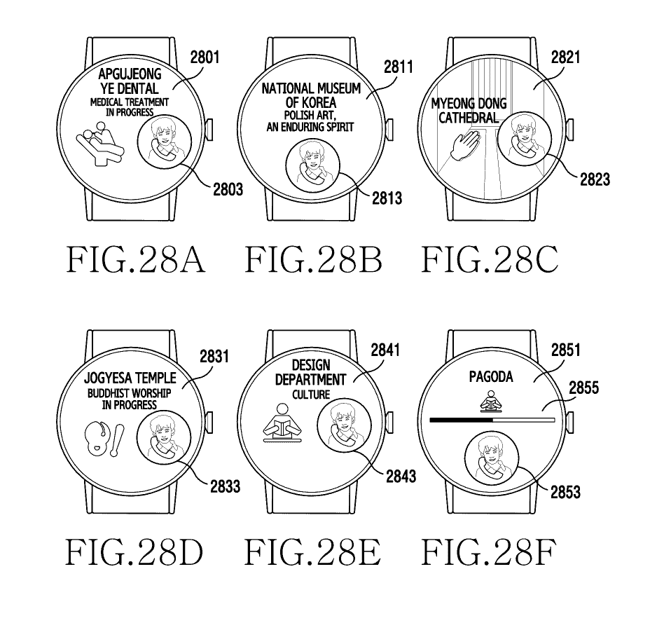

Referring to FIGS. 28A, 28B, 28C, 28D, 28E and 28F, the electronic device 200 can display the current context of the user of the electronic device 200, or display the current context and a motion of the user of the electronic device 200 according to the current context, in the 1st region 210 of the screen of the electronic device 200, thereby displaying that the user of the electronic device 200 is now in a state in which contact is impossible. For example, in case where the electronic device 200 senses that the user of the electronic device 200 is now in medical treatment in a hospital, the electronic device 200 can transmit a screen 2801 including an image, a text, and a motion displaying that the user of the electronic device 200 is in medical treatment of FIG. 28A, to a counterpart 2803 displayed in the 2nd region 220 of the screen.

For another example, in case where the electronic device 200 senses that the user of the electronic device 200 is now viewing in a museum, the electronic device 200 can transmit a screen 2811 including an image and text of FIG. 28B to a counterpart 2813 displayed in the 2nd region 220 of the screen. For further example, in case where the electronic device 200 senses that the user of the electronic device 200 is now in a cathedral, the electronic device 200 can transmit a screen 2821 including an image and text of FIG. 28C to a counterpart 2823 displayed in the 2nd region 220 of the screen. For yet another example, in case where the electronic device 200 senses that the user of the electronic device 200 is now in a temple, the electronic device 200 can transmit a screen 2831 including an image and text of FIG. 28D to a counterpart 2833 displayed in the 2nd region 220 of the screen. For still another example, in case where the electronic device 200 senses that the user of the electronic device 200 is now in class, the electronic device 200 can transmit a screen 2841 including an image and text of FIG. 28E to a counterpart 2843 displayed in the 2nd region 220 of the screen. That is, the electronic device 200 can transmit a screen including a name of a class that is being taken, a name of a professor of the class, the time elapsed among the whole class time, etc. to the counterpart 2843. For still another example, in case where the electronic device 200 senses that the user of the electronic device 200 is now in class, the electronic device 200 can transmit a screen 2851 including an image, text and motion taking a class of FIG. 28F to a counterpart 2853 displayed in the 2nd region 220 of the screen. Particularly, the electronic device 200 can display the time elapsed among the whole class time 2855 and transmit the displayed time to the counterpart as well.

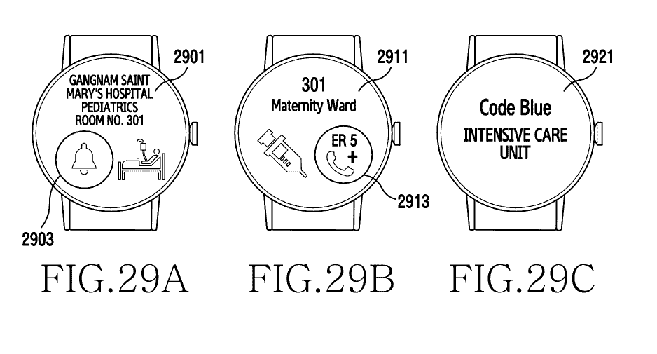

FIGS. 29A, 29B and 29C are diagrams illustrating an example of a screen for providing information quickly in an electronic device according to various example embodiments of the present disclosure.

According to an example embodiment of the present disclosure, the electronic device 200 can sense current contextual information, and transmit the sensed current contextual information to another user. The user of the electronic device 200 can transmit the current contextual information to the another user, thereby transmitting information that the user of the electronic device 200 needs.

Referring to FIGS. 29A, 29B and 29C, the electronic device 200 can display the current context of the user of the electronic device 200 in the 1st region 210 of the screen of the electronic device 200 and, if sensing an input from the user and if it is, though not sensing the input, a preset case, the electronic device 200 can transmit information displayed in the 1st region 210 to another user. For example, in case where the electronic device 200 senses that the user of the electronic device 200 is now in hospital, the electronic device 200 can transmit an image and text 2901 of FIG. 29A, to a counterpart 2903 displayed in the 2nd region 220 of the screen. Accordingly to this, in case where the user of the electronic device 200 is now in hospital, the user of the electronic device 200 can transmit information calling a medical staff. For another example, in case where the electronic device 200 senses that the user of the electronic device 200 is now giving medical treatment, the electronic device 200 can transmit an image and text 2911 of FIG. 29B to a counterpart 2913 displayed in the 2nd region 220 of the screen. Accordingly to this, in case where the user of the electronic device 200 is now giving medical treatment, the user of the electronic device 200 can transmit information that the user of the electronic device 200 is treating a patient of room number 301, to the another user. For further example, as illustrated in FIG. 29C, the user of the electronic device 200 can now display an image for an urgent call, and transmit the displayed image to another user or receive information about the urgent call from the another user as well.

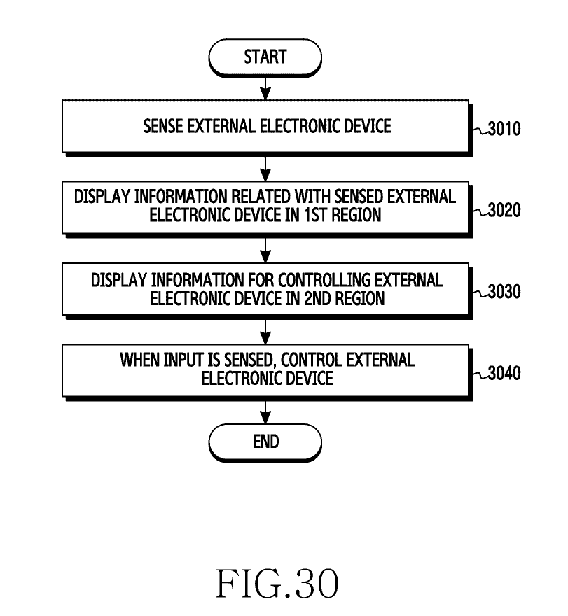

FIG. 30 is a flowchart illustrating an example operation of providing information when sensing an external electronic device in an electronic device according to various example embodiments of the present disclosure.

In operation 3010, the electronic device 200 can sense an external electronic device. The external electronic device can include an electronic device capable of performing communication with the electronic device 200. For example, the external electronic device can include a TV, an audio, a car, or a server managing a system of the electronic device. The electronic device 200 can perform coupling with the external electronic device through a communication network. The communication network can include WiFi, Bluetooth, and/or a network capable of performing communication including data communication, etc. In operation 3020, the electronic device 200 can display information about the currently coupled external electronic device in the 1st region of the screen of the electronic device 200. In operation 3030, the electronic device 200 can display information for controlling the external electronic device in the 2nd region 220 of the screen of the electronic device 200. The information for controlling the external electronic device can include information about up/down, left/right, information about play, information about volume adjustment, etc. In operation 3040, in case where an input is sensed, the electronic device 200 can perform control of the sensed external electronic device. For example, in case where the coupled external device is a TV, the electronic device 200 can adjust a channel or volume, or control the execution of the external electronic device, or control locking of a door of a coupled car, or control start-up as well.

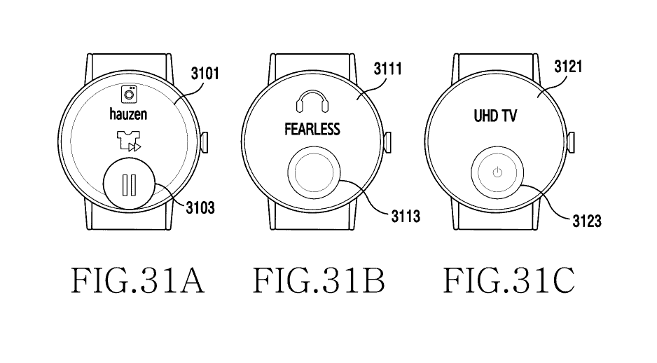

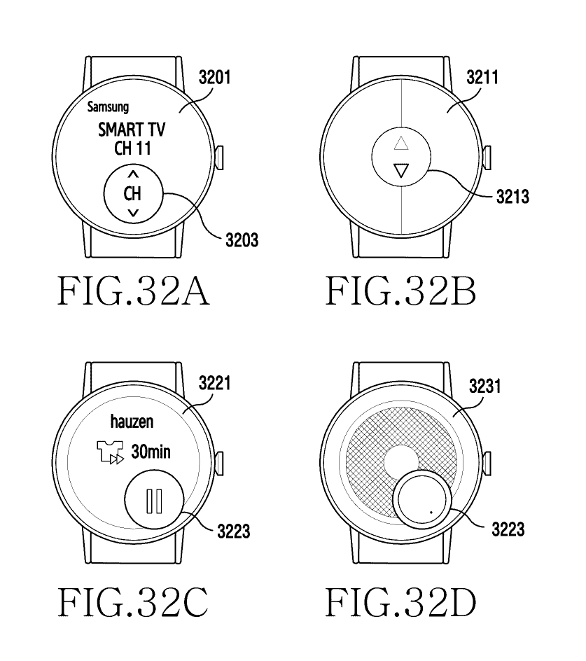

FIGS. 31A, 31B, 31C, 32A, 32B, 32C and 32D are diagrams illustrating examples of a screen displayed in an electronic device in order to provide information when the electronic device senses an external electronic device in FIG. 30.

According to an example embodiment of the present disclosure, the electronic device 200 can sense a currently coupled external electronic device, and control the sensed external electronic device.

Referring to FIGS. 31A, 31B, and 31C and FIGS. 32A, 32B, 32C and 30 32D, the electronic device 200 can display the currently coupled external electronic device in the 1st region 210 of the screen, and display a menu for controlling the coupled external electronic device in the 2nd region 220 of the screen. Information about the menu for controlling the external electronic device can be received from the external electronic device, or be different according to user's setting.

For example, in case where the electronic device 200 has been currently coupled with a washing machine, the electronic device 200 can display an image such as reference numeral 3101 of FIG. 31A in the 1st region 210 of the screen of the electronic device 200, and display a menu 3103 for controlling an operation of the washing machine in the 2nd region 220. By using the displayed menu, the user of the electronic device 200 can control the operation of the coupled washing machine.

For another example, in case where the electronic device 200 has been currently coupled with a headset, the electronic device 200 can display an image such as reference numeral 3111 of FIG. 31B in the 1st region 210 of the screen of the electronic device 200, and display a menu 3113 for controlling the headset in the 2nd region 220. Accordingly to this, by using the electronic device 200, the user of the electronic device 200 can control a volume of the headset.

For further example, in case where the electronic device 200 has been currently coupled with a TV, the electronic device 200 can display an image such as reference numeral 3121 of FIG. 31C in the 1st region 210 of the screen of the electronic device 200, and display a menu 3123 for controlling the TV in the 2nd region 220. Accordingly to this, by using the electronic device 200, the user of the electronic device 200 can control an on/off of the TV.

For example, in case where the electronic device 200 has been currently coupled with a TV, the electronic device 200 can display an image such as reference numeral 3201 of FIG. 32A in the 1st region 210 of the screen of the electronic device 200, and display a menu 3203 for controlling a channel of the TV in the 2nd region 220. By using the displayed menu, the user of the electronic device 200 can control the channel of the coupled TV.

For another example, in case where the electronic device 200 has been currently coupled with an elevator, the electronic device 200 can display an image such as reference numeral 3211 of FIG. 32B in the 1st region 210 of the screen of the electronic device 200, and display a menu 3213 for controlling the elevator in the 2nd region 220. Accordingly to this, by using the electronic device 200, the user of the electronic device 200 can call the elevator when being in front of the elevator, or select a floor number of the elevator after boarding the elevator.

For further example, in case where the electronic device 200 has been currently coupled with a washing machine, the electronic device 200 can display an image such as reference numeral 3221 of FIG. 32C in the 1st region 210 of the screen of the electronic device 200, and display a menu 3223 for controlling the washing machine in the 2nd region 220. Accordingly to this, by using the electronic device 200, the user of the electronic device 200 can control working of the washing machine, pause thereof, or reservation thereof.

For yet another example, in case where the electronic device 200 has been currently coupled with a speaker, the electronic device 200 can display an image such as reference numeral 3231 of FIG. 32D in the 1st region 210 of the screen of the electronic device 200, and display a menu 3233 for controlling the speaker in the 2nd region 220. Accordingly to this, by using the electronic device 200, the user of the electronic device 200 can adjust a volume of the speaker.

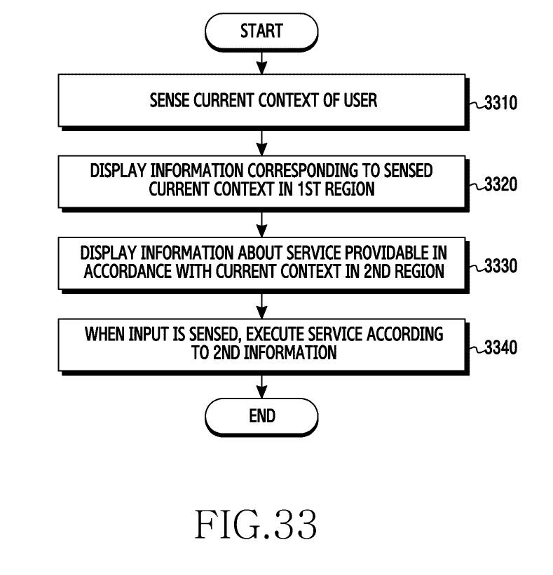

FIG. 33 is a flowchart illustrating an example operation of providing service information providable in accordance with a current state in an electronic device according to various example embodiments of the present disclosure.

According to the present disclosure, after the electronic device 200 senses contextual information, the electronic device 200 can display information about a service providable in current context.

Referring to FIG. 33, in operation 3310, the electronic device 200 can sense current contextual information. The contextual information can include information about a current location of the electronic device 200 or the user of the electronic device 200, a motion thereof, an environment thereof, etc. In operation 3320, the electronic device 200 can display information corresponding to the current contextual information in the 1st region 210 of the screen of the electronic device 200. In operation 3330, the electronic device 200 can display information about a service providable in accordance with the current context, in the 2nd region 220. The information about the service providable in accordance with the current context can include information about the service available in the current context, detailed information about the current context, etc. In operation 3340, in case where an input to the 2nd region 220 is sensed, the electronic device 200 can perform an operation for the service providable in accordance with the current context displayed in operation 3330.

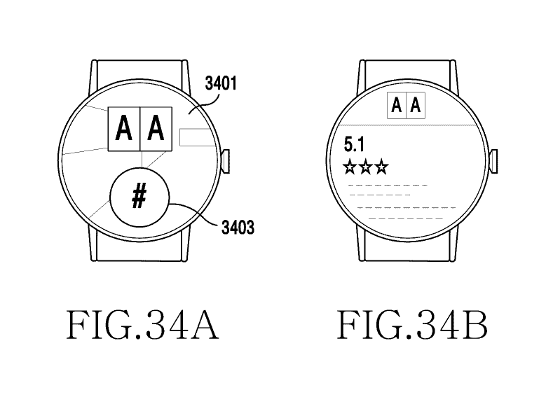

FIGS. 34A and 34B are diagrams illustrating an example of a screen displayed in an electronic device in order to provide service information providable in accordance with a current state in the electronic device according to various example embodiments of the present disclosure.

Referring to FIG. 34A, in case where currently sensed contextual information is contextual information about a restaurant, the electronic device 200 can display a screen 3401 of the restaurant in the 1st region 210 of the screen of the electronic device 200. The electronic device 200 can display an image 3403 for search in the 2nd region 220 of the screen of the electronic device 200 so that the user of the electronic device 200 may search information about the restaurant currently displayed in the 1st region 210. In case where the electronic device 200 senses an input, the electronic device 200 can, as in FIG. 34B, display the search result of the restaurant displayed on the screen 3401.

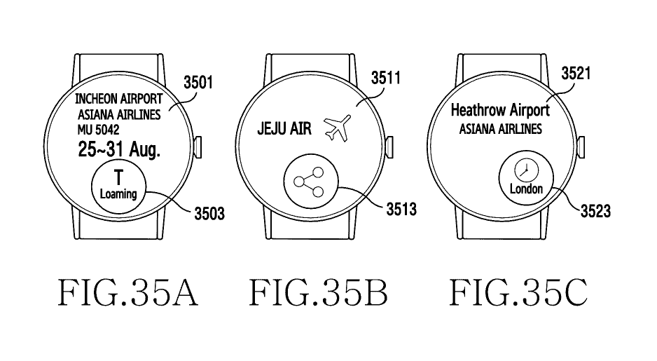

FIGS. 35A, 35B and 35C are diagrams illustrating an example of a screen displayed in an electronic device in order to provide service information providable in accordance with a moving means in the electronic device according to various example embodiments of the present disclosure.

Referring to FIGS. 35A, 35B and 35C, in case where currently sensed contextual information is contextual information about flight use, the electronic device 200 can display screens 3501, 3511 and 3521 of flight context in the 1st region 210 of the screen of the electronic device 200. The electronic device 200 can display images 3503, 3513 and 3523 of operations providable according to the flight context displayed in the 1st region 210, in the 2nd region 220 of the screen of the electronic device 200.

In one example embodiment, referring to FIG. 35A, in case where a location where the electronic device 200 is now located is an airport, the electronic device 200 can display information 3501 about an aircraft which the user will board, in the 1st region 210 of the screen of the electronic device 200, and display a screen 3503 for providing an oversea roaming coupling service in the 2nd region 220 of the screen of the electronic device 200. According to this, in case where the user of the electronic device 200 is located in the airport, the user of the electronic device 200 can perform an input to the electronic device 200 and perform a motion for use of the roaming coupling service.

In another example embodiment, referring to FIG. 35B, in case where a location where the electronic device 200 is now located is inside an aircraft, the electronic device 200 can display information 3511 about the aircraft which the user has boarded, in the 1st region 210 of the screen of the electronic device 200, and display a screen 3513 for providing information that contact is impossible within the aircraft, in the 2nd region 220 of the screen of the electronic device 200. Accordingly to this, in case where the user of the electronic device 200 is located inside the aircraft, the user can perform an input to the electronic device 200, and provide another user with the information that the contact is impossible because the user is now located inside the aircraft.

In a further example embodiment, referring to FIG. 35C, in case where a location where the electronic device 200 is now located is an airport of a destination, the electronic device 200 can display information 3521 about the airport at which the user has arrived, in the 1st region 210 of the screen of the electronic device 200, and display a screen 3523 for providing a service for changing time into time corresponding to an arrived country, in the 2nd region 220 of the screen of the electronic device 200. Accordingly to this, in case where the user of the electronic device 200 arrives at an airport of another country, the user can perform an input to the electronic device 200 and change the time of the electronic device 200 into the time of the arrived country.

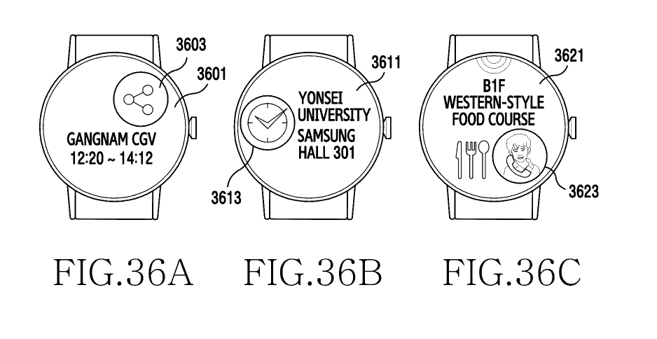

FIGS. 36A, 36B and 36C are diagrams illustrating an example of a screen displayed in an electronic device in order to provide service information providable in accordance with context in the electronic device according to various example embodiments of the present disclosure.

Referring to FIGS. 36A, 36B and 36C, the electronic device 200 can display screens 3601, 3611 and 3621 of currently sensed context, in the 1st region 210 of the screen of the electronic device 200. The electronic device 200 can display images 3603, 3613 and 3623 of operations providable according to the context displayed in the 1st region 210, in the 2nd region 220 of the screen of the electronic device 200.

In one example embodiment, referring to FIG. 36A, in case where a location where the electronic device 200 is now located is a theater, the electronic device 200 can display information 3601 about a movie which the user has purchased in advance, in the 1st region 210 of the screen of the electronic device 200, and display a screen 3603 for sharing the previously purchased movie with another human, in the 2nd region 220 of the screen of the electronic device 200. In case where there is not the information about the movie that the user has purchased in advance, the electronic device 200 can display a list of movies that are possible to be purchased in advance as well. According to this, in case where the user of the electronic device 200 is located in the theater, the user can perform an input to the electronic device 200 and share information about a previously purchased movie with another human.

In another example embodiment, referring to FIG. 36B, in case where a location where the electronic device 200 is now located is a school, the electronic device 200 can display information 3611 about a lecture room in which the user is located, in the 1st region 210 of the screen of the electronic device 200, and display a screen 3613 for attendance check in the 2nd region 220 of the screen of the electronic device 200. Accordingly to this, the user of the electronic device 200 can perform the attendance check in the lecture room, using the electronic device 200.

In a further example embodiment, referring to FIG. 36C, in case where a location where the electronic device 200 is now located is a restaurant, the electronic device 200 can display information 3621 about a menu of the restaurant, in the 1st region 210 of the screen of the electronic device 200, and display a screen 3623 for a call from a counterpart, in the 2nd region 220 of the screen of the electronic device 200. Accordingly to this, in case where the user of the electronic device 200 is having a meal in the restaurant, the user can provide information about the restaurant to another user who has sent a call request.

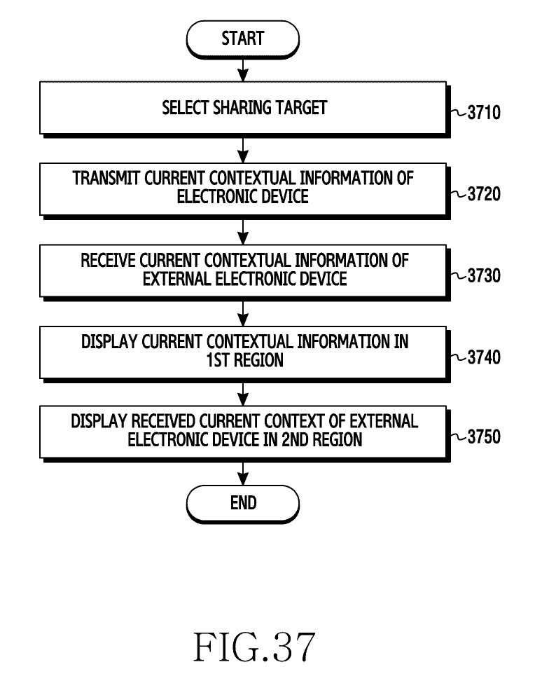

FIG. 37 is a flowchart illustrating an example operation for sharing contextual information with an external electronic device in an electronic device according to various example embodiments of the present disclosure.

According to one example embodiment of the present disclosure, the electronic device 200 can share contextual information with an external electronic device. The electronic device 200 can transmit current contextual information to the external electronic device, and receive current contextual information of the external electronic device, thereby sharing the contextual information in real-time. For the sake of talking with a friendly counterpart through the electronic device 200 or for the purpose of care of another human, the user of the electronic device 200 can continuously share state information with another object.

In operation 3710 of FIG. 37, the electronic device 200 can select an external electronic device that will share contextual information. The external electronic device can be an electronic device of a user for a user that a user previously designates. In operation 3720, the electronic device 200 can transmit current contextual information to the selected external electronic device. In operation 3730, the electronic device 200 can receive current contextual information of the selected external electronic device from the selected external electronic device. In operation 3740, the electronic device 200 can display the current contextual information of the electronic device 200 in the 1st region 210 of the screen of the electronic device 200. In operation 3750, the electronic device 200 can display the current contextual information of the external electronic device in the 2nd region 220 of the screen of the electronic device 200. Through this, the user of the electronic device 200 can real-time share the current contextual information with a user of the external electronic device.

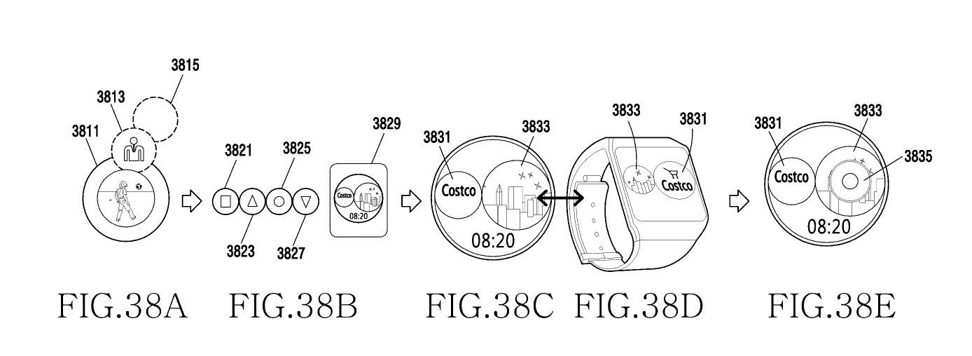

FIGS. 38A, 38B, 38C, 38D and 38E are diagrams illustrating an example of a screen displayed in an electronic device when the electronic device shares contextual information with an external electronic device in FIG. 37.

Referring to FIG. 38, FIG. 38A illustrates a screen for selecting an external electronic device that will share the contextual information illustrated in operation 3710. Reference numeral 3811 of FIG. 38A represents a user of an external electronic device currently activated. The user of the electronic device 200 can select one of at least one or more users 3811 and 3813 stored in an address book. Also, after the user of the electronic device 200 selects a specific icon 3815 for selecting a new user, the user of the electronic device 200 can input information about the new user and select the new user as well.

FIG. 38B illustrates an example of a screen for transmitting, by the electronic device 200, current contextual information to the selected external electronic device in operation 3720 of FIG. 37. The user of the electronic device 200 can select any one of several screens 3821, 3823, 3825, 3827 and 3829 capable of showing current context, and transmit the selected screen to the external electronic device.

FIGS. 38C and 38D illustrate examples of a screen on which the current context of the external electronic device is shared and displayed with the electronic device 200 in operation 3720 to operation 3750 of FIG. 37. The electronic device 200 and the external electronic device can display shared contextual information in real time in a 1st region or 2nd region of a screen of each of the electronic device and the external electronic device. For example, the electronic device 200 can, as illustrated in FIG. 38C, display the current context 3831 of the electronic device 200 and the current context 3833 of the external electronic device, and the external electronic device can, as illustrated in FIG. 38D, display the current context 3831 of the electronic device 200 and the current context 3833 of the external electronic device.

FIG. 38E illustrates an example of a screen for performing communication between users who are sharing contextual information. The users who are sharing current contextual information in real time can perform a voice talk in real time. For example, in case where the user of the electronic device 200 performs an input on a portion in which current contextual information 3833 of a user of an external electronic device is displayed, an image such as reference numeral 3835 of FIG. 38E is output and, while the image is being output, the user of the electronic device 200 can perform a real-time talk with the user of the external electronic device. Here, the performing of the input can be a scheme touching and/or touching-and-holding the portion in which the current contextual information 3833 of the user of the external electronic device is displayed, or a method set by the user.

In case where the electronic device 200 according to an example embodiment of the present disclosure senses contextual information, the electronic device 200 can display an image and text in the 1st region 210 and 2nd region 220 of the screen and show current context, or display an icon for an operation according to this. According to another example embodiment, though not illustrated in the drawings, in case where the electronic device 200 senses contextual information, the electronic device 200 can notify the current contextual information to the user through a sound or vibration as well. For example, in case where the electronic device 200 senses that it is context displayed in FIG. 2B, the electronic device 200 can output the sound that “I'm jogging” and display current contextual information. The current contextual information can be displayed along with an image by the electronic device 200, or the image and a sound can be ouput together, or only the sound can be output separately as well. Also, the electronic device 200 can sense a specific sound from the user of the electronic device 200 and, if sensing the specific sound, the electronic device 200 can perform control of contextual information as well. For example, in case where the electronic device 200 senses a specific sound, the electronic device 200 can transmit current contextual information to the external, or display additional information about the current contextual information, or perform control of a device related with the current contextual information as well.

Methods according to example embodiments described in the present disclosure can be implemented in the form of hardware (e.g., circuitry), software, or a combination of the hardware and the software.

In case where the methods are implemented in the form of software, a computer-readable storage medium storing one or more programs (i.e., software modules) can be provided. The one or more programs stored in the computer-readable storage medium are configured to be executable by one or more processors within an electronic device. The one or more programs include instructions for enabling the electronic device to execute the methods according to the example embodiments stated in the claims or specification of the present disclosure.

These programs (i.e., software modules and/or software) can be stored in a Random Access Memory (RAM), a non-volatile memory including a flash memory, a Read Only Memory (ROM), an Electrically Erasable Programmable ROM (EEPROM), a magnetic disc storage device, a Compact Disc—ROM (CD-ROM), Digital Versatile Discs (DVDs), an optical storage device of another form, and/or a magnetic cassette. Or, the programs can be stored in a memory that is configured in combination of some or all of them. Also, each configuration memory can be included in plural as well.

Also, the program can be stored in an attachable storage device that is accessible through a communication network such as the Internet, an intranet, a Local Area Network (LAN), a Wireless LAN (WLAN) and a Storage Area Network (SAN), or a communication network configured in combination of them. This storage device can connect to a device performing an example embodiment of the present disclosure through an external port. Also, a separate storage device on the communication network can connect to the device performing the example embodiment of the present disclosure as well.

In the example embodiments of the present disclosure, constituent elements included in the disclosure have been expressed in a singular form or plural form in accordance with an example embodiment. But, the expression singular form or plural form is selected suitable to proposed context for description convenience sake, and the present disclosure is not limited to singular or plural constituent elements. Despite a constituent element expressed in the plural form, the constituent element can be constructed in the singular form or, despite a constituent element expressed in the singular form, the constituent element can be constructed in the plural form.

An electronic device according to various example embodiments of the present disclosure can provide contextual information based on a state of a user even without user's additional handing.

The electronic device according to the various example embodiments of the present disclosure can transmit a current environment state of the user and an intention of the user even by simple handling only.

While a detailed description of the present disclosure has been provided with respect to various example embodiments, it will be understood that various modifications can be made without departing from the scope of the present disclosure. Therefore, the scope of the present disclosure should not be limited and defined by the described example embodimenst and should be defined by not only the scope of claims claimed below but also equivalents to the scope of these claims.

What is claimed is:

1. A method for providing information in an electronic device, the method comprising:
sensing a current context of the electronic device;
displaying first information corresponding to the sensed current context in a first region of a screen of the electronic device;
displaying second information in a second region of the screen of the electronic device; and
controlling, when an input is sensed by the electronic device, the first information based on an operation that the second information indicates.

2. The method of claim 1, wherein the first information comprises location information, movement information, coupled service information and coupled device information.

3. The method of claim 1, wherein the second information comprises information representing a user's intention, and the information representing the user's intention comprises information for sharing, information for device execution, and information for service coupling.

4. The method of claim 1, wherein the input comprises a drag input from the first region to the second region.

5. The method of claim 4, further comprising, displaying a designated user list when a drag input is sensed.

6. The method of claim 5, further comprising transmitting the first information and the second information to a selected user among the designated user list.

7. The method of claim 1, further comprising displaying a service providable in the sensed current context, in the second region, based on the sensed current context of the electronic device.

8. The method of claim 1, further comprising recognizing a movement and displaying the movement in the first region.

9. The method of claim 1, further comprising:
sensing an external electronic device;
displaying the sensed external electronic device in the first region; and
displaying a screen for controlling the external electronic device in the second region.

10. The method of claim 1, wherein the electronic device senses an input through an input device, and the input device comprises a touch screen.

11. An electronic device comprising:
a display configured to display a first region and a second region;
an input unit comprising input circuitry; and
a processor operatively coupled with the display and the input unit,
wherein the processor is configured to sense a current context of the electronic device, and to control the display to display first information corresponding to the sensed current context in the first region, and to control the display to display second information in the second region and to control, when an input through the input unit is sensed, the first information based on an operation that the second information indicates.

12. The device of claim 11, wherein the first information comprises location information, movement information, coupled service information, and coupled device information.

13. The device of claim 11, wherein the second information comprises information representing a user's intention, and the information representing the user's intention comprises information for sharing, information for device execution, and information for service coupling.

14. The device of claim 11, wherein the input circuitry of the input unit is configured to sense a drag input from the first region to the second region.

15. The device of claim 14, wherein the processor is configured to control the display to display a designated user list when a drag input is performed.

16. The device of claim 15, wherein the processor is configured to transmit the first information and the second information to a selected user from the designated user list.

17. The device of claim 11, wherein the processor is configured to control the display to display a service providable in the sensed current context, in the second region, based on the sensed current context of the electronic device.

18. The device of claim 11, wherein the processor is configured to control the display to recognize a movement and display the movement in the first region.

19. The device of claim 11, wherein the processor is configured to sense an external electronic device, and to control the display to display the sensed external electronic device in the first region, and to control the display to display a screen for controlling the external electronic device in the second region.

20. The device of claim 11, wherein the input circuitry comprises a touch screen.
